(19) United States
(12) Patent Application Publication
(10) Pub. No.: US 2015/0312517 A1
(43) Pub. Date: Oct. 29, 2015

(54) Combined Video, Chip and Card Monitoring for Casinos

(71) Applicant: Magnet Consulting, Inc., Incline Village, CA (US)

(72) Inventors: Joshua K. Hoyt, Portland, OR (US); Forrest S. Seitz, Beaverton, OR (US)

(73) Assignee: Magnet Consulting, Inc., Incline Village, CA (US)

(21) Appl. No.: 14/261,971

(22) Filed: Apr. 25, 2014

(51) Int. Cl. H04N 5/775; H04N 5/77; G11B 27/19; H04N 1/21; H04N 7/18; G07F 17/32; H04N 5/76

(52) U.S. Cl. CPC H04N 5/775; G07F 17/3241; H04N 5/77; H04N 5/7605; H04N 1/2112; H04N 7/183; G11B 27/19

(57) ABSTRACT

A system and method of monitoring events in a casino. The system combines chip monitoring, card monitoring and video monitoring to identify problems, both in real-time as well as for historical review. The system uses the card information to transition between various game states in order to determine whether the chip actions are allowed, and to generate alerts when the chip actions are not allowed. The system also uses the card information to identify winning and losing bets in order to verify that the collections and payouts of chips are correct.

### CROSS REFERENCE TO RELATED APPLICATIONS

Not applicable.

### BACKGROUND

The present invention relates to gaming, and in particular, to monitoring events at a table game using a combination of video data, casino chip data and card data.

Unless otherwise indicated herein, the approaches described in this section are not prior art to the claims in this application and are not admitted to be prior art by inclusion in this section.

In support of their primary business of providing gaming entertainment, casinos perform the following business related functions: security, customer specific marketing, dealer training, regulatory compliance, and cash management.

The state-of-the-art regarding security: Video surveillance is the standard method to monitor environments that require security. Typically, video cameras are used to view and record these environments. In the absence of specific events (e.g., a discrepancy at the cashier or a player winning more than expected), the video record is rarely reviewed and is typically is discarded after a predetermined amount of time.

The state-of-the-art regarding customer specific marketing: Player profiles for casino table games are woefully inaccurate. Typically, the “floor”—responsible for multiple tables in a “pit”—monitors the bets of each player and manually enters an estimate of the average bet. This input is then combined with “hands per hour” to extrapolate the house income and hence the value of each player. The house then decides how much it wants to re-invest in each player in the form of “comps”.

The state-of-the-art regarding dealer training: Generally training is provided in a customer-free environment in order to provide a basic level of competence. Once the dealer is dealing to customers, qualitative evaluation may be performed by management observation, and quantitative evaluation may be performed by tracking the hands per hour or a similar metric.

The state-of-the-art regarding regulatory compliance varies according to the jurisdiction. Typically, adherence to the laws is validated with spot checks. California has unique laws in which the casino is not allowed to have a stake in the game. The role of the casino is simply to host the games. The casino is compensated for this hosting by collecting a commission that is based on a combination of (1) the bets on the table, and (2) one of 15 collection “schedules” defined by the California Department of Justice (DOJ). It is the dealer's job (along with many others) to sum up the bets in play and—having memorized the appropriate schedule—calculate the collection. The current state-of-the-art for collecting the “house ante” uses a simple metal guillotine to hold the designated chips during a game and subsequently drop them into the drop box. The money in the drop box is not correlated with either of the two inputs that determine the amount of money that should be there.

The state-of-the-art regarding cash management: Many existing casinos use only two check points to manage cash: 1) the dealer tray leaving the cashier, and 2) the dealer tray returning to the cashier.

### SUMMARY

There is a need to improve the operation of the above-noted functions in a casino.

Regarding security, one issue with existing systems is that in the gaming world, the events that trigger reviews of the archived security video are indirect (e.g., the cash returned to the cashier is different from what is expected) and not correlated to the root cause of the discrepancy. The result is that security personnel must spend an inordinate amount of time reviewing the archived video to infer the actual event.

Regarding customer specific marketing, the problems and limitations of the manual estimation approach include that each player's bet can vary with each hand, and that the odds vary with each type of bet.

Regarding dealer training, dealer skills are highly variable. The challenge is to impose rules that enhance consistency without being onerous. Smaller casinos and card rooms have high turnover and cannot afford to invest heavily in training Finally, metrics of dealer performance are qualitative at best.

Regarding regulatory compliance, there is currently no substitute for spot checks. In California, the potential problems include errors in estimating the bets in play, using the wrong schedule, applying the schedule incorrectly, and errors in calculating the commission. The drop box contributes to these problems by not attributing specific errors to their root cause.

Regarding cash management, any discrepancies caught when checking the dealer tray back into the cashier are difficult to trace back to any specific event. In addition, the substantial time interval between these check points makes it very difficult for the casino to understand its cash position at any one time.

In response to the above-noted shortcomings, an embodiment provides a system that integrates card readers, chip readers, and video surveillance to fundamentally change how casinos manage their security, customer specific marketing, dealer training, regulatory compliance, and cash management.

Regarding security, an embodiment implements a system for time stamping and labeling specific events that can guide the review of the security video record. These time stamps and labels for different types of events can streamline the identification of problems—creating the following opportunities:
increased speed of finding the root cause of security events allows personnel to address issues “in the moment” (near real-time),
increased efficiency of identifying and classifying events allows for more effective use of security personnel (they can focus on key problem areas and monitor a larger number of environments), and
increased effectiveness of security allows for more centralized monitoring.

Regarding customer specific marketing, an embodiment implements a system to track each player's bets on a game by game basis that takes into account the specific odds of each bet made. Tracking with this level of fidelity creates the following opportunities:
a clear understanding of the value of each player,
a clear understanding of the betting habits of each player,
more accurate “comps”,
more targeted promotions, and
aberrations from the statistical norm

Regarding dealer training, an embodiment implements a system that can capture erratic dealer behavior and identify repeated error patterns.

Regarding regulatory compliance, an embodiment insures that each game is tracked and can be re-played to insure proper play. One embodiment—tailored to the laws of California—implements a system to automatically calculate the bets in play and apply the correct schedule to guide the dealer in collecting the proper commission. In addition, the system may include an RFID-enabled drop box (also referred to as an instrumented drop box) that the system uses to monitor the game-by-game take, to ensure that the take for any one game matches the expected amount based on the amounts bet, to track the total take for a user-defined time window, to track the “hands per hour”, to perform checks and balances between the take at the table and the subsequent tally at the cashier, and to generate additional inputs into automated table tracking methods.

Regarding cash management, an embodiment implements a system that tracks the house cash position on a game-by-game basis.

A method monitors events in a casino environment. The method includes receiving, from a video camera, video data of a table game in the casino environment. The method includes receiving, from a radio-frequency identification chip monitor, casino chip data of the table game. The casino chip data includes at least one casino chip location (e.g., where the chip has been placed on the table) and at least one casino chip identifier (e.g., an identifier that identifies the value of the chip). The method includes receiving, from a game result monitor, game result data of the table game. The game result data includes at least one game result identifier (e.g., that a particular card has been dealt such as King of Spades, that a particular dice roll has occurred such as hard 7, that a particular roulette number has been hit such as double-zero). The method includes displaying together the video data, the casino chip data and the game result data to enhance monitoring of the events at the table game. This allows for events at the table to be monitored and evaluated more easily than existing systems.

The casino chip data may be received contemporaneously with the video data. The game result data may be received contemporaneously with the video data.

The method may further include storing the video data, the casino chip data and the game result data having been received. This allows for a review of historical information.

The video data may have a plurality of video data timestamps. The casino chip data may have a plurality of casino chip data timestamps. The game result data may have a plurality of game result data timestamps. The method may include displaying together the video data, the casino chip data and the game result data using the plurality of video data timestamps, the plurality of casino chip data timestamps, and the plurality of game result data timestamps.

The method may further include receiving a user input that selects a timestamp. The method may further include displaying together the video data, the casino chip data and the game result data at the timestamp selected by the user input. This allows for a review of historical information at the selected timestamp.

The method may further include accessing a chip database using the at least one casino chip identifier. The method may further include receiving, from the chip database, at least one casino chip value that corresponds to the at least one casino chip identifier. The method may further include displaying the at least one casino chip value when displaying the casino chip data. This allows for monitoring the values of bets placed.

The at least one casino chip location may be a dealer tray. The at least one casino chip identifier may be at least one casino chip being located in the dealer tray. Displaying the casino chip data enhances monitoring of the at least one casino chip being located in the dealer tray. This allows for monitoring the value of chips in, coming into, or going out of, the dealer tray.

The radio-frequency identification chip monitor may be a radio-frequency identification drop box. The at least one casino chip location may be a read area of the radio-frequency identification drop box. The at least one casino chip identifier is at least one casino chip being located in the read area. Displaying the casino chip data enhances monitoring of the at least one casino chip being located in the read area. This allows for monitoring the accuracy of the house collection.

The method may further include accessing a commission schedule. The at least one casino chip location may be a read area of the radio-frequency identification drop box. The at least one casino chip identifier may be at least one casino chip being located in the read area. The method may further include computing a commission amount by applying the commission schedule to the at least one casino chip being located in the read area. The method may further include displaying the commission amount when displaying the video data, the casino chip data and the game result data. This allows for monitoring the accuracy of the commission collected.

The method may further include accessing rules of the table game. The method may further include monitoring the casino chip data to identify when a violation of the rules of the table game has occurred. The method may further include generating an alert when the casino chip data indicates that the violation has occurred.

The method may further include accessing rules of the table game. The rules may be associated with a set of states. The method may further include changing from a first state of the set of states to a second state of the set of states according to the game result data.

The method may further include receiving customer identification data corresponding to a customer participating in the table game. The method may further include correlating the customer identification data with the casino chip data. The method may further include displaying the customer identification data having been correlated to enhance evaluating the customer.

The method may further include receiving dealer identification data corresponding to a dealer operating the table game. The method may further include correlating the dealer identification data with the casino chip data and the game result data. The method may further include displaying the dealer identification data having been correlated to enhance evaluating the dealer.

The game result monitor may be one of a card monitor, a roulette monitor and a dice monitor.

An apparatus monitors events in a casino environment. The apparatus includes a video camera, a radio-frequency identification chip monitor, a game result monitor, and a computer system. The video camera generates video data of a table game in the casino environment. The radio-frequency identification chip monitor generates casino chip data of the table game. The casino chip data includes at least one casino chip location and at least one casino chip identifier. The game result monitor that generates game result data of the table game. The game result data includes at least one game result identifier. The computer system receives and displays together the video data, the casino chip data and the game result data to enhance monitoring of the events at the table game.

The apparatus may implement other features similar to those described above regarding the method.

A computer program stored on a non-transitory computer readable medium controls a computer system to monitor events in a casino environment. The computer program includes a video component, a chip monitor component, a game result monitor component, and an output component. The video component receives video data of a table game in the casino environment. The chip monitor component receives casino chip data of the table game. The casino chip data includes at least one casino chip location and at least one casino chip identifier. The game result monitor component receives game result data of the table game. The game result data includes at least one game result identifier. The output component outputs together the video data, the casino chip data and the game result data to enhance monitoring of the events at the table game.

The computer program may implement other features similar to those described above regarding the method.

Another method monitors events in a casino environment. The method includes receiving, from a radio-frequency identification chip monitor, casino chip data of the table game. The casino chip data includes at least one casino chip location and at least one casino chip identifier. The method includes receiving, from a game result monitor, game result data of the table game. The game result data includes at least one game result identifier. The method includes accessing rules of the table game according to the at least one game result identifier. The method includes monitoring the casino chip data to identify when a violation of the rules of the table game has occurred. The method includes generating an alert when the casino chip data indicates that the violation has occurred.

The method may include other features similar to those described above regarding the first method.

The following detailed description and accompanying drawings provide a further understanding of the nature and advantages of embodiments of the present invention.

### BRIEF DESCRIPTION OF THE DRAWINGS

FIG. 1 is a block diagram of an event monitoring system.

FIG. 2 is a block diagram of an event monitoring system and additional component details.

FIG. 3 is a block diagram of an event monitoring system and additional component details.

FIG. 4 is a flowchart 400 that describes the general operation of the event monitoring system and related components.

FIG. 5 shows timing diagrams resulting from the system monitoring a game of Baccarat.

FIG. 6 shows timing diagrams resulting from the system monitoring a game of Baccarat.

FIG. 7A shows an overall flow diagram for EZ Baccarat.

FIG. 7B shows an overall flow diagram for punto banco Baccarat.

FIG. 8 shows a detailed flow diagram for the Tableau box 800 of FIGS. 7A-7B.

FIG. 9 shows a detailed flow diagram for the Payout box 900 of FIG. 7A

FIG. 10 is a screen layout for the pre-game state.

FIG. 11 is a screen layout for the bets allowed state.

FIG. 12 is a screen layout for the bets locked state.

FIG. 13 is a screen layout for the payout state.

FIG. 14 shows an example of a game review screen.

FIG. 15 is an example screen display showing the game review mode in operation.

FIG. 16A is a graph showing dealer performance.

FIG. 16B is a graph showing dealer errors.

FIG. 16C is a graph showing banker performance.

FIG. 16D is a graph showing player performance.

FIG. 16E is a graph showing casino performance.

FIG. 16F is a graph showing game performance at the casino.

### DETAILED DESCRIPTION

Described herein are techniques for casino event monitoring. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In the following description, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

The following description uses the term “casino gaming chip”. Equivalent terms include token, RFID token, gaming chip, RFID gaming chip, chip, casino chip, RFID chip, etc.

Tracking the location of gaming tokens in real-time on a gaming table has the potential to revolutionize the gaming industry by providing improved security, targeted marketing, accurate training metrics, traceable regulatory compliance, and precise cash management while simultaneously streamlining the associated tasks.

Typical RFID-enabled tokens, automated card readers, and overhead surveillance cameras each address a subset of the problems. For example, a typical RFID system has a poorly defined “working volume” resulting in an inability to track a multitude of individual closely spaced bets. This shortcoming severely limits the practicality of this technology to simply identifying counterfeit tokens. Earlier inventions (U.S. Pat. No. 8,395,252, U.S. Pat. No. 8,395,507 and U.S. Pat. No. 8,432,283) use an enhanced RFID tracking technology with a “ferrite core” to overcome this shortcoming. Specifically, the technology described in these patents allows the tracking of individual bets and payouts.

The embodiments described in this document leverage the data collected using these earlier inventions in combination with additional information collected from card readers, overhead cameras, instrumented pay slots, and other auxiliary input/output devices to identify specific “events” that are relevant to casino security, player profiles, dealer performance, regulatory compliance, and cash management. The additional information that can be generated from an integrated system that harnesses these inputs may include one or more of the following:
knowing which cards are in play (what cards were dealt),
knowing how the cards are being played (where cards were dealt),
knowing the total bets placed for each hand,
knowing who bet what and compiling this information into a player profile of habits of individual players,
knowing the odds for each bet made,
knowing who won and who lost each hand,
knowing the correct payout for winning bets,
knowing the total cash equivalent in the dealer tray,
knowing dealer metrics (e.g., the number of hands played during a given time interval),
knowing the number/type of dealer errors and tracking these trends over time, and
knowing the value of the house “ante” or commission (if any).

A noteworthy feature of embodiments is the ability to (1) take disparate inputs, (2) identify specific events of interest, and (3) time stamp them, such that any subsequent review can:
for security: target both “what to look for” and “when to look for it”,
for marketing: identify player habits and practices on a game-by-game basis and then aggregate this data into meaningful customer profiles,
for training: identify specific dealer errors and track performance over time,
for regulatory compliance: show that bets and collections adhere to DOJ requirements, and
for cash management: track the ebb and flow of money on a game-by-game basis.

Embodiments integrate one or more of the following pieces of technology:
RFID-enabled chip readers of the type described in the following patents: U.S. Pat. No. 8,395,252, U.S. Pat. No. 8,395,507 and U.S. Pat. No. 8,432,283; the chip reader may also read chips placed in an instrumented drop box build into each table as well as tally the chips in the dealer tray
Card readers (either scanners/cameras or RFID-enabled cards integrated into the shoe or optical recognition from overhead cameras)
An overhead surveillance camera

This integration has the following benefits for key stakeholders. The benefits for security include identification and time-stamping of events/alarms, increased speed of finding root cause, near real-time response to incidents, and more centralized control. The benefits for marketing include better player profiles and marketing campaigns that are more accurately targeted. The benefits for training include more efficient identification of dealer errors and improved metrics of dealer performance. The benefits for regulatory compliance include improved accountability and game-by-game traceability of money. The benefits for cash management include the game-by-game tracking of wins, losses, and commissions/collections.

A noteworthy feature of embodiments is to take disparate technologies and bind them together with automated logic to identify specific “events” at specific times. This logic can then parse these events by type to determine how the resulting information should be disseminated or aggregated to address the needs of individual stakeholders.

The following is a partial list of “events” that can be identified automatically using this invention:
introduction of an illegal chip,
late/changed bets,
“capped” bets,
incorrect collection of losing bets,
overpayment of winning bets,
underpayment of winning bets,
incorrect drawing of extra cards, and
incorrect collection of commissions (if any).

In addition to these automated methods, the system includes a manual button for manually pressing “help” (e.g., as a way for dealer to alert security).

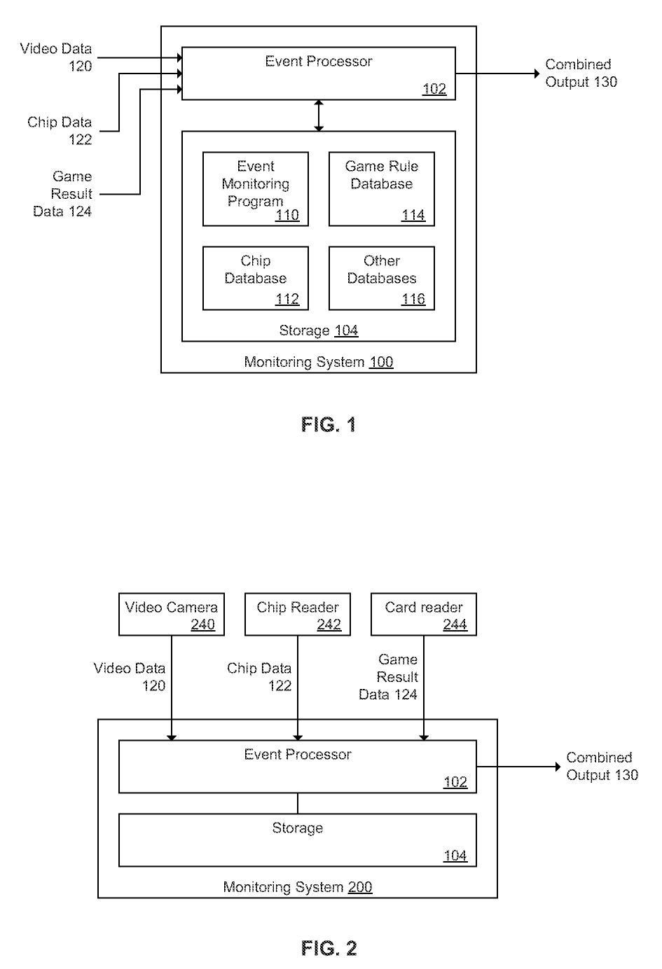

FIG. 1 is a block diagram of an event monitoring system 100 (also referred to as the casino monitoring system, the monitoring system or just “the system”). The event monitoring system 100 includes an event processor 102 and storage 104. The storage 104 stores data and computer programs used by the event monitoring system 100; shown in the figure are an event monitoring program 110, a chip database 112, a game rule database 114, and other databases 116. The event monitoring system 100 receives as inputs video data 120, chip data 122 and game result data 124, and generates as output combined output 130 that includes the video data 120, chip data 122 and game result data 124. The event monitoring system 100 may also receive additional inputs and access additional databases (e.g. dealer ID, player ID); these additional details are set forth in subsequent sections.

The event monitoring program 110 generally controls the operation of the event monitoring system 100, when executed by the event processor 102. Further details of the event monitoring program 110 are provided below. Note that when various functions are described as being performed by the event monitoring system 100, the more precise description is that the event processor 102, as programmed according to the event monitoring program 110, controls the event monitoring system 100 to perform the functions.

The video data 120 corresponds to one or more video data streams that have captured the actions at one or more gaming tables in the casino. For example, the video data 120 may show the players at the gaming table, the dealer, player actions such as bets, dealer actions such as collections and payouts, and gaming table actions such as the cards dealt (e.g., Baccarat), dice rolls (e.g., craps) or numbers hit (e.g., roulette). For ease of illustration, the video data 120 is discussed as being associated with one gaming table, with the understanding that a similar discussion is applicable to video data from multiple devices or multiple gaming tables.

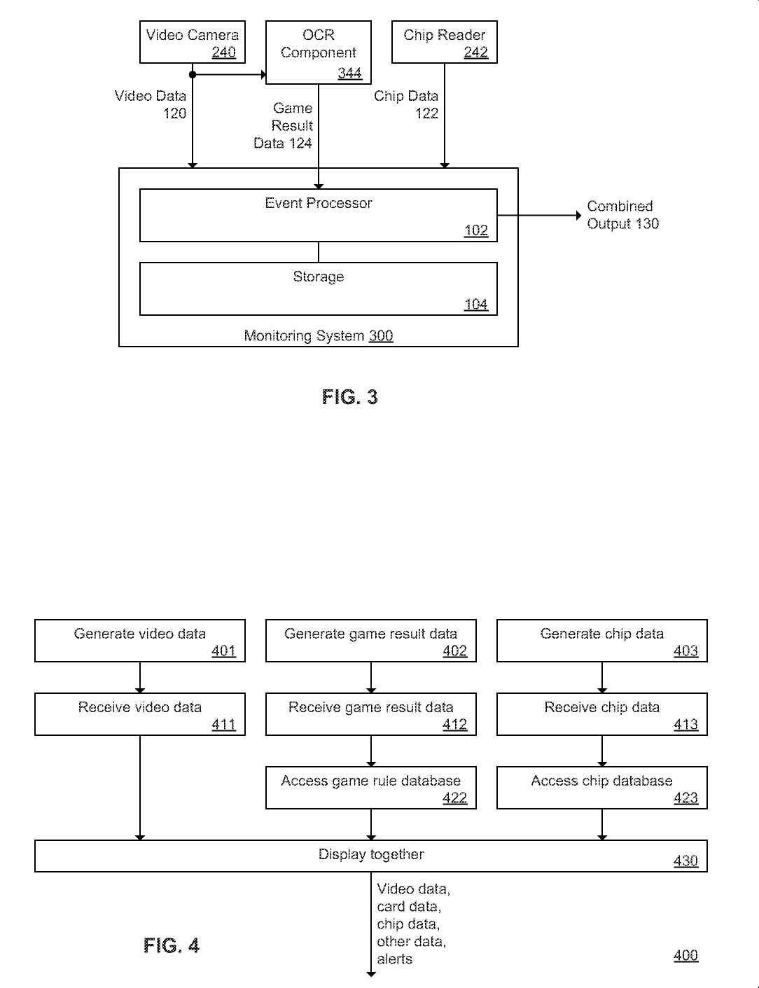

The chip data 122 corresponds to the detection of one or more gaming chips at one or more locations on one or more gaming tables. For example, if a player places three gaming chips at a particular location on the gaming table, the chip data 122 reflects that. For ease of illustration, the chip data 122 is discussed as being associated with one gaming table, with the understanding that similar discussion is applicable to chip data from multiple devices or multiple gaming tables. In general, the chip data 122 corresponds to chip identifications performed by a device monitoring the table (see, e.g., FIG. 2 or FIG. 3), referred to as a chip monitor. A gaming chip includes a radio frequency identification (RFID) circuit that has an identifier that is detected by an RFID antenna; the chip data 122 then includes the identifier and information indicating the detecting antenna, in order to indicate that the specific gaming token was detected by the specific antenna (which is associated with a defined location).

The game result data 124 corresponds to the detection of one or more gaming cards, one or more roulette results, or one or more dice results on one or more gaming tables. For ease of illustration, the game result data 124 is discussed as being associated with one gaming table, with the understanding that similar discussion is applicable to game result data from multiple devices or multiple gaming tables. In general, the game result data 124 corresponds to game result identifications performed by a device monitoring the table (see, e.g., FIG. 2 or FIG. 3), referred to as a game result monitor. The identification of a gaming card depends on the type of gaming cards used in each game. For example, standard gaming cards are in a deck of 52 cards having four suits (clubs, diamonds, hearts, spades) and 13 ranks (ace, king, queen, jack, ten, nine, eight, seven, six, five, four, three, two); the identification would include the specific suit and the specific rank of a detected gaming card. In some games, the suit is irrelevant; in such a case the game result data 124 from a game at a particular table may include only the rank. Often the content of the game result data 124 is determined by the specific device or detection system used (see, e.g., FIG. 2 or FIG. 3), and the event processor 102 just uses the portion of the data it needs for a particular monitoring function.

The combined output 130, as mentioned above, includes the video data 120, chip data 122 and game result data 124. The combined output 130 may also include other information detected by or generated by the gaming table and sent to the casino monitoring system 100, such as player identification information, dealer identification information, etc. These additional components of the combined output 130 are detailed in subsequent sections.

The chip database 112 contains data that corresponds the identifiers of casino chips (e.g., as provided in the chip data 122) to chip values. For example, a particular gaming chip may have an RFID circuit with a 32-bit identifier; the chip database 112 relates that identifier to a chip value, e.g. $100. As another example, the identifier includes information that indicates the chip value. As further detailed below, the combined output 130 contains chip values instead of chip identifiers, making it easier for casino personnel to monitor the action.

The game rule database 114 contains data that corresponds to the rules of one or more casino games. These rules may be stored as a set of states that the game progresses through over the course of a game. Certain card actions and chip actions are allowed or disallowed at various stages of the game. Since the casino monitoring system 100 is monitoring the chip data 122 and the game result data 124, it can detect when a specific card action or chip action violates the rules. This process is discussed in more detail below.

The other databases 116 contain additional data as further detailed below. Examples of the data in the other databases 116 include a dealer identification database, a player identification database, a stored games database, a commission schedule database, a comp tracking database, etc.

The event monitoring system 100 may be implemented by a computer that executes the event monitoring program 110 using its processor (e.g., the event processor 102, when so programmed). In general, the event processor 102 processes the inputs (e.g., the video data 120, chip data 122 and game result data 124) and generates the combined output 130 that also includes additional data generated by accessing the databases (e.g., the chip database 112 and game rule database 114), according to the inputs.

The event monitoring system 100 generally operates as follows (see also FIG. 4). Input devices capture the video data 120, chip data 122 and game result data 124 for one or more gaming tables at the casino, and send the inputs to the event monitoring system 100, which is located in a back office of the casino. Casino employees view the combined output 130 and can pay special attention to events that the event monitoring system 100 indicates as it monitors whether the input data (e.g., the video data 120, chip data 122 and game result data 124) conforms to the databases (e.g., the chip database 112 and game rule database 114). As an example, when the chip data 122 indicates a chip has been placed on the gaming table at a time in violation of the game rules, the event monitoring system 100 generates an alert for the casino employee to view in the combined output 130. (Alerts may also be referred to as alarms.) Further details of the types of monitoring performed by the event monitoring system 100 are provided below.

FIG. 2 is a block diagram of an event monitoring system 200 and additional component details. The event monitoring system 200 is otherwise similar to the event monitoring system 100 (see FIG. 1) and components similar to those in FIG. 1 are not shown. Specifically, a video camera 240 captures the video data 120, a chip reader device 242 captures the chip data 122, and a card reader device 244 captures the game result data 124. The devices are generally implemented in (or otherwise capture data from) a gaming table. The devices send the captured data to the event monitoring system 200 via a network (e.g., Ethernet network).

The video camera 240 may be implemented by a video camera device that generates the video data 120 as a digital data stream. If more than one digital data stream is being sent to the event monitoring system 200, the video camera 240 may include a source identifier in the video data 120. The video camera 240 may also include timestamps in the video data 120.

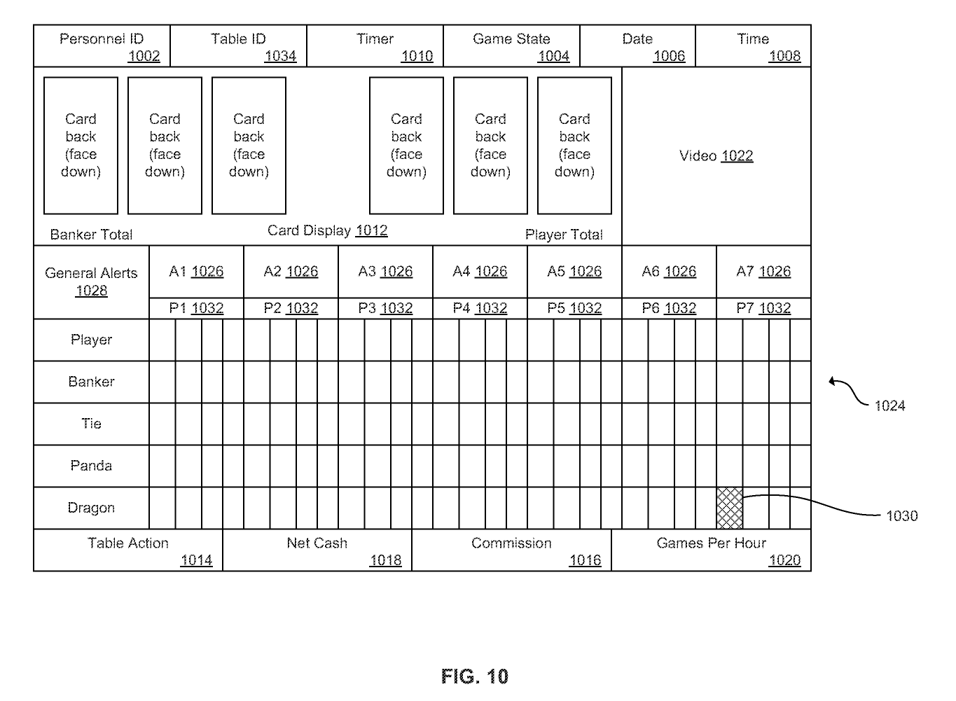

The chip reader device 242 may be implemented by one or more RFID antennas under the surface of the gaming table. Each antenna has an associated location on the table, so when the antenna reads the RFID chip in a particular gaming token, the token is associated with that location. The locations on the gaming table generally correspond to betting areas (see, e.g., FIG. 10 for examples in Baccarat), plus other special locations such as a commission collection area, a dealer tray, etc. The chip reader device 242 sends the location data associated with the token identifier as part of the chip data 122. In a casino environment with more than one table, the chip reader device 242 may include a table identifier as part of the chip data 122. The chip reader device 242 may also include timestamps in the chip data 122. An example of the chip reader device 242 is an RFID gaming system as described in U.S. Pat. No. 8,432,283.

The card reader device 244 may be implemented by an instrumented card shoe. (A card shoe typically contains more cards than a single deck; the card shoe may be provided to the dealer with a full complement of shuffled cards ready to be dealt.) As the dealer deals a card from the shoe, sensors in the shoe read the identifier of the card. The shoe may perform the identification optically (e.g., reading the visible rank and suit information, reading codes or other machine-readable identifiers printed on the cards, etc.), electromagnetically (e.g., reading RFID circuits in or on the cards), etc. Generally the identifier includes the rank and suit, although reading the rank is sufficient for games where the suit is irrelevant. The card reader device 244 sends the card identifier as part of the game result data 124. In a casino environment with more than one table, the card reader device 244 may include a table identifier as part of the game result data 124. The card reader device 244 may also include timestamps in the game result data 124. Examples of the card reader device 244 include an instrumented card shoe as described in U.S. Pat. No. 6,039,650, and various devices from Bally Technologies including the iDeal™ shuffler, the MD3™ shuffler, and the i-Shoe Auto™ shoe.

As discussed above, the combined output 130 includes the video data 120, chip data 122 and game result data 124. When these data have timestamps, the event monitoring system 200 may use the timestamps to coordinate display of the video data 120, chip data 122 and game result data 124. Alternatively, the event monitoring system 200 may insert timestamps into the video data 120, chip data 122 and game result data 124 when they are received.

FIG. 3 is a block diagram of an event monitoring system 300 and additional component details. The event monitoring system 300 is similar to the event monitoring system 200 (see FIG. 2), except that the game result data 124 is generated by an optical character recognition (OCR) component 344 instead of the card reader device 244 (see FIG. 2). The OCR component 344 is a computer program that performs OCR on the video data 120. The OCR component 344 may be executed by the event monitoring system 300 itself, or may be executed by a separate computer that communicates the game result data 124 to the event monitoring system 300. Otherwise the OCR component 344 operates in a manner similar to that of the card reader device 244 (see FIG. 2). Examples of the OCR component 344 include the system described in U.S. Pat. No. 8,016,665, and the TableEye™ system from Tangam Systems.

FIG. 4 is a flowchart 400 that describes the general operation of the event monitoring system (e.g., 100 in FIG. 1, 200 in FIG. 2 or 300 in FIG. 3) and related components. At 401, the video camera (e.g., 240 in FIG. 2) generates video data of the table game. At 402, the game result monitor (e.g., the card reader device 244 in FIG. 2 or the OCR component 344 in FIG. 3) generates game result data of the table game. At 403, the chip monitor (e.g., the chip reader device 242 of FIG. 2) generates casino chip data of the table game. In general, the components are performing 401-403 continuously during operation of the event monitoring system, and add timestamps to their data streams.

At 411, the event monitoring system receives the video data (e.g., 120 in FIG. 1). At 412, the event monitoring system receives the game result data (e.g., 124 in FIG. 1). At 413, the event monitoring system receives the casino chip data (e.g., 122 in FIG. 1). The event monitoring system can add timestamps when the data are received at 411-413 (e.g., if one or more of the data do not have timestamps, to replace existing timestamps with new timestamps, etc.).

At 422, the event monitoring system accesses the game rule database using the game result data. For example, when the game result data indicates a new card has been played on the gaming table, the game rules may indicate that the game changes from one state to another (e.g., from a state in which betting is allowed to a state where betting is no longer allowed). This process is discussed in more detail below.

At 423, the event monitoring system accesses the chip database using the casino chip data. As discussed above, the event monitoring system uses the chip database to correspond the identifiers of gaming chips to gaming chip values. The chip values are more convenient than the identifiers when the casino chip data is displayed or viewed by casino personnel.

At 430, the event monitoring system displays together the video data, the game result data and the casino chip data according to the timestamps. The event monitoring system may also display other data resulting from accessing the databases (e.g., the state of the game). As an example, over the course of a game, the event monitoring system displays video data showing the actions as they occur over the course of the game, displays game result data showing the rank and suit of the cards as they are played over the course of the game, and displays casino chip data showing the number of chips and the total value at each location as they are played over the course of the game. Based on the information accessed in the game rule database and the chip database, the event monitoring system may also generate alerts. The alert may be associated with the data according to the timestamps. For example, if the chip data indicates a bet is made when the game rules (as indicated by the game result data, e.g., card results, roulette results, dice rolls for “craps”, etc.) state that bets are not allowed, this violates the game rules; the system may display an alert along with the video data, the game result data and the casino chip data. Casino personnel who see the alert may immediately see the circumstances (the video data, the game result data and the casino chip data) and may act accordingly. Furthermore, in a review situation, the casino personnel may quickly scan through a set of alerts, using the timestamps to quickly review the circumstances.

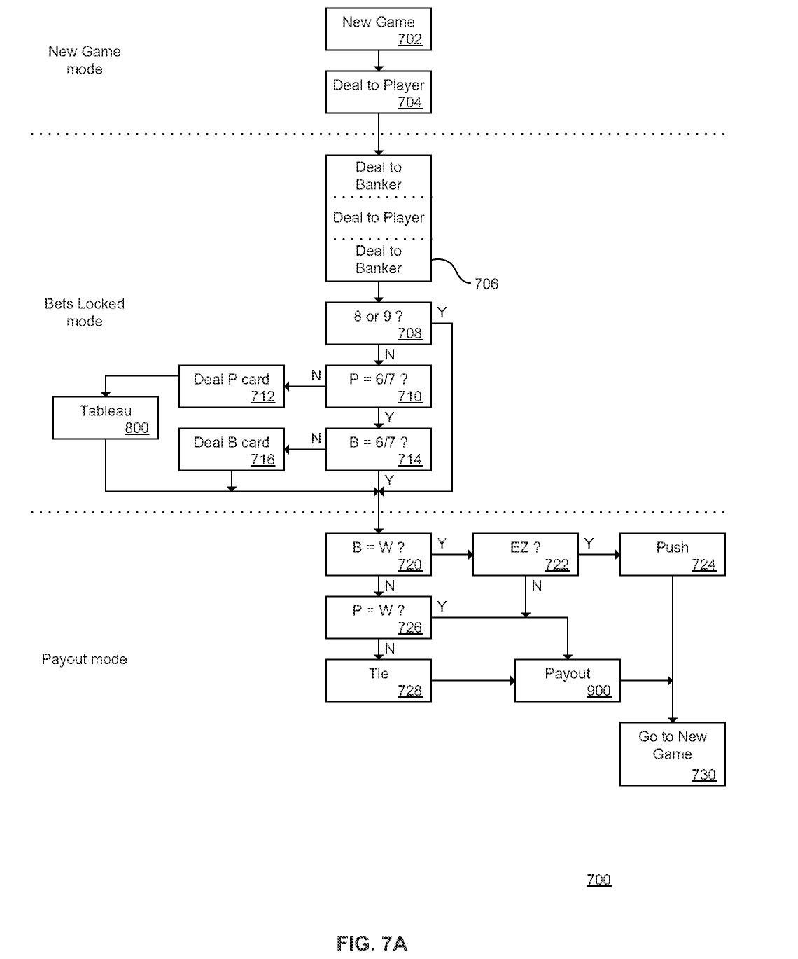

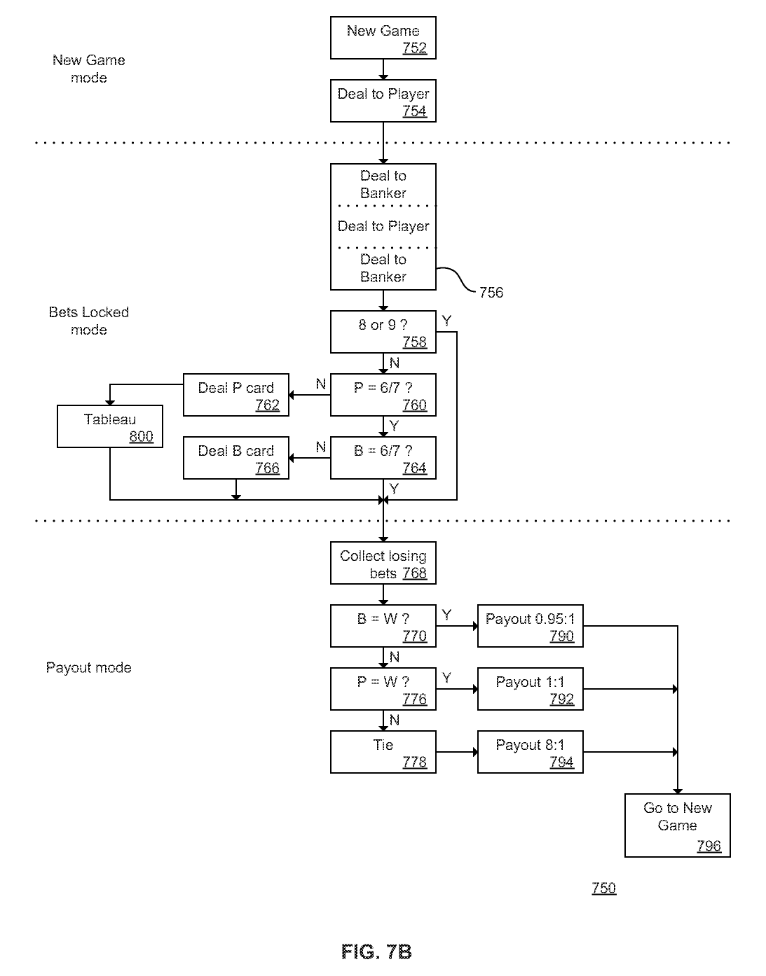

A variant embodiment combines chip data and game result data without the video data. As such, the video components (e.g., the video camera 240 of FIG. 2, the video generation box 401 of FIG. 4, etc.). The operation of this variant embodiment is generally as follows. As in FIG. 4 at 402 and 403, the input devices (e.g., the chip monitor and the game result monitor) generate the chip data and the game result data. As at 412 and 413, the system receives the chip data and the game result data. The system accesses the rules of the game using a game result identifier in the game result data. The game result identifier may correspond to one result in which one set of game rules are applicable, or to another result in which another set of game rules are applicable. In general, the system uses the game result data to move through various defined game states (see, e.g., FIGS. 7A, 7B, 8 and 9). The system monitors the chip data to identify when a violation of the rules of the game has occurred, according to which set of rules is applicable at the various times as per the game result data. The system generates an alert when the chip data indicates that the violation has occurred.

For example, and as described more fully below, in EZ Baccarat as shown in FIG. 7A, bets are allowed in the “new game” state (through state 704), and bets are not allowed once the “bets locked” state is entered (when state 706 is entered). These states correspond to the rules of the game. The system is tracking the states using the game result data of the cards being dealt. The system is tracking the bets using the chip data. Thus, when the system is in the “bets locked” state and detects chip movement, the system generates an alert.

Further regarding the variant embodiment, the system may use the chip data to access the rules of the game. For example, a game rule may be that the system transitions from the end of the current game to the start of the next game when the casino's commission charge is processed. (This operation is described more fully below.) The system may also use other data to access the rules of the game, depending upon the implementation. For example, the gaming table may include a reset switch that reverts the system to the “new game” state.

In general, the information displayed corresponds to the data sent by the devices, augmented by the data accessed in the databases. For example, a gaming chip is displayed not according to its RFID identifier (the raw data read by the chip monitor), but according to its value (resulting from accessing the chip database). Further details are provided below regarding the additional types of data gathered, the format of the data displayed, and the alerts.

Example Event Monitoring System for Baccarat

The event monitoring system may be applied to a variety of table games in a casino, including blackjack, poker, double hand poker, roulette, craps, etc. The following sections describe an example event monitoring system for Baccarat. Before providing the details of the system, general information regarding Baccarat is provided.

Baccarat Background Info

In Baccarat, cards 2-9 are worth face value; 10, J, Q, K are worth zero; and Aces are worth 1 point. Hands are valued according to the rightmost digit of the sum of their constituent cards: for example, a hand consisting of 2 and 3 is worth 5, but a hand consisting of 6 and 7 is worth 3 (the rightmost digit of the total, 13). The highest possible hand value is 9. In the game, a “Baccarat” refers to anything with a value of zero; in a hand of K, 4 and 6, the King is a “baccarat”, and the hand value is also “baccarat”.

Baccarat games were originally social and private gambling games, but now are played widely in casinos. Varieties include Punto banco and EZ Baccarat.

Punto Banco

The overwhelming majority of casino baccarat games in the United States, United Kingdom, Canada, Australia, Sweden, Finland, and Macau, are “Punto banco” baccarat. In Punto banco, the casino banks the game at all times, and commits to playing out both hands according to fixed drawing rules, known as the “tableau” (French for “board”), in contrast to more historic baccarat games where each hand is associated with an individual who makes drawing choices. Player (“Punto”) and Banker (“banco”) are simply designations for the two hands dealt out in each coup, two outcomes which the bettor can back; Player has no particular association with the customer, nor Banker with the house. In some countries, this version of the game is known as tableau.

Punto banco is dealt from a shoe containing 4, 6 or 8 decks of cards shuffled together. A cut-card is placed in front of the seventh-last card, and the drawing of the cut-card indicates the last coup of the shoe. For each coup, two cards are dealt face up to each hand, starting from “player” and alternating between the hands. The croupier may call the total (e.g. “Five Player, three Banker”). If either Player or Banker or both achieve a total of 8 or 9 at this stage, the coup is finished and the result is announced: Player win, a Banker win, or tie. If neither hand has eight or nine, the drawing rules are applied to determine whether Player should receive a third card. Then, based on the value of any card drawn to the player, the drawing rules are applied to determine whether the Banker should receive a third card. The coup is then finished, the outcome is announced and winning bets are paid out.

The tableau of drawing rules for punto banco:

If neither the Player nor Banker is dealt a total of 8 or 9 in the first two cards (known as a “natural”), the tableau is consulted, first for Player's rule, then Banker's.

Player's rule: If Player has an initial total of 0-5, he draws a third card. If Player has an initial total of 6 or 7, he stands.

Banker's rule: If Player stood pat (i.e., has only two cards), the banker regards only his own hand and acts according to the same rule as Player. That means Banker draws a third card with hands 0-5 and stands with 6 or 7. If Player drew a third card, the Banker acts according to the following more complex rules:
If Player drew a 2 or 3, Banker draws with 0-4, and stands with 5-7.
If Player drew a 4 or 5, Banker draws with 0-5, and stands with 6-7.
If Player drew a 6 or 7, Banker draws with 0-6, and stands with 7.
If Player drew an 8, Banker draws with 0-2, and stands with 3-7.
If Player drew an ace, 9, 10, or face card, the Banker draws with 0-3, and stands with 4-7.

The casinos list these rules in a more easily remembered format as follows:
If the banker total is 2 or less, then the banker draws a card, regardless of what the player's third card is.
If the banker total is 3, then the bank draws a third card unless the player's third card was an 8.
If the banker total is 4, then the bank draws a third card if the player's third card was 2, 3, 4, 5, 6, 7.
If the banker total is 5, then the bank draws a third card if the player's third card was 4, 5, 6, or 7.
If the banker total is 6, then the bank draws a third card if the player's third card was a 6 or 7.
If the banker total is 7, then the banker stands.

A math formula equivalent to the drawing rules is: take the value of Player's third card, counting 8 and 9 as −2 and −1. Divide by 2, always rounding down towards zero. (Thus −1, 0, 1 all round to zero when this division is done.) Add three to the result. If the Banker's current total is this final value or less, then draw; otherwise, stand.

The croupier will deal the cards according to the tableau and the croupier will announce the winning hand: either Player or Banker. Losing bets will be collected and the winning bets will be paid according to the rules of the house. Usually, even money or 1-to-1 will be paid on Player bets and 95% to Banker bets (even money with “5% commission to the house”).

Should both Banker and Player have the same value at the end of the deal the croupier shall announce “egalité—tie bets win”. All tie bets will be paid at 8-to-1 odds and all bets on Player or Banker remain in place and active for the next game. (The customer may or may not be able to retract these bets depending on casino rules.)

EZ Baccarat: No-Commission Baccarat

EZ Baccarat is a proprietary variation of baccarat and is preferred in many casinos around the world. The EZ Baccarat draw rules and outcomes are identical to those of classic baccarat, with the following exception: a winning Banker bet is paid even money (1-to-1, instead of the 19-to-20 of standard Baccarat) except when it wins with a three-card point total of seven, in which case it is a “push” or a “barred” hand. The house edge on a Banker bet under EZ Baccarat rules is 1.018%, which is just slightly lower than the house edge on the Banker bet in standard commission-based baccarat. The use of this EZ Baccarat “push rule” is equivalent to taking a 4.912% commission out of every winning Banker bet payout. The three-card seven-point winning Banker hand (called a “Dragon 7”) occurs about twice per eight-deck shoe. In addition to the no-commission feature, EZ Baccarat has two additional side bets: the Dragon 7 and the Panda 8. The Dragon 7 is a one-coup bet that always loses except when the Banker bet wins with a three-card score of seven. The Dragon 7 pays 40-to-1 when won and has a house edge of 7.61%. The Panda 8 bet is a one-coup bet that always loses except when the Player bet wins with a three-card score of eight. The Panda 8 bet pays 25-to-1 when won and has a house edge of 10.18%. The addition of the Dragon 7 and Panda 8 side bets, along with the significant increase in the number of coups dealt per hour, results in increased casino hold percentages from EZ Baccarat play. Apart from the principal benefit of increased game speed, casinos prefer EZ Baccarat not only because it eliminates both errors in calculating commissions and disputes with customers over proper commission amounts, but also because EZ Baccarat is often much easier for the casino staff to operate and supervise than is classic baccarat.

In this embodiment for Baccarat, the following game states were defined and used to develop the logic necessary to label these events: pre-game (PG), new game (NG), bets locked (BL), payout (PO), and end of game (EG).

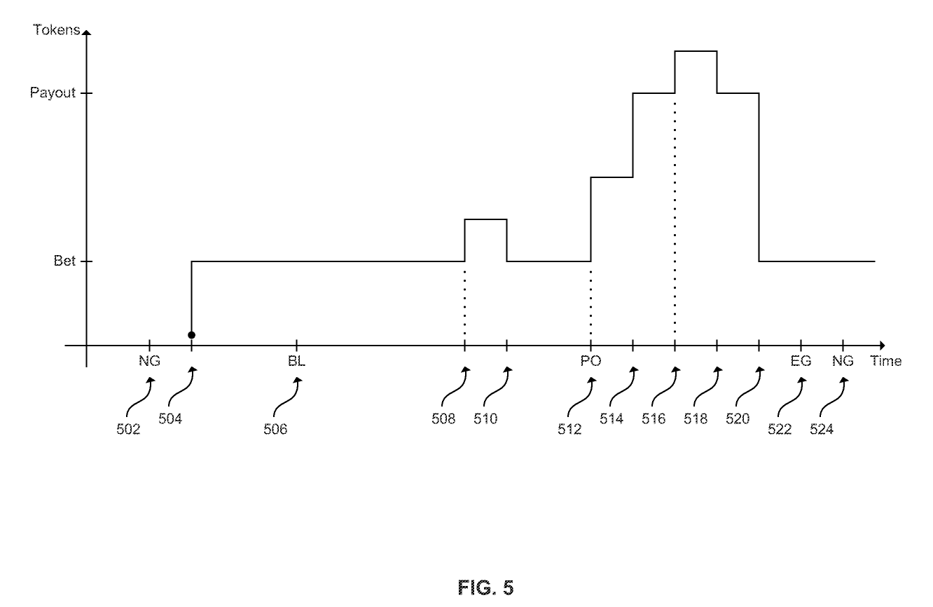

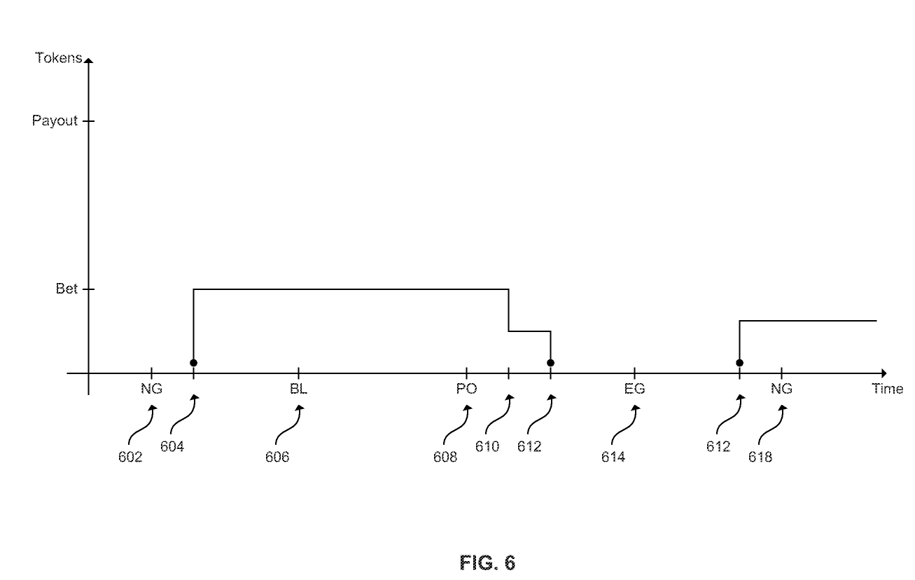

FIGS. 5-6 show timing diagrams resulting from the system monitoring a game of Baccarat. The x-axis is time, and the y-axis is the quantity (or alternatively, the value) of tokens detected. The event monitoring system (e.g., 100 in FIG. 1) may display the information shown in FIGS. 5-6 as part of the combined output 130, in formats similar to those shown in FIGS. 5-6 or in other formats as shown in other figures. FIG. 5 shows a timing diagram of a bet placed at one spot, and FIG. 6 shows a timing diagram of a bet placed at another spot. Key delimiters that define the various games states (also referred to as modes) include:
The “new game” state starts at any time that the system begins monitoring. No bets are tracked during this game state. The system may track the chips and display the resulting data, but since the rules allow bets to be moved around during this state, no illegal move alerts are generated. An exception is that detecting an illegal chip will generate an illegal chip alert in this state. The “pre-game” state is similar to the “new game” state except that the video data and game result data are not being generated.
The “bets locked” state starts when the first card is dealt (e.g., as detected and identified by the game result monitor). Any changes to bets in this state are flagged as “late bets”.
The “payout” mode starts when the hand has been dealt. Data from the game result monitor (e.g., the card shoe or an overhead optical character recognition system) is used to identify this change in state. (See FIGS. 7-9 for the various states that can be identified.)
The “end of game” can be triggered by a number of events including (but not limited to) correct payout (e.g., as detected by the chip monitor), correct collection of losing bets, the pressing of a momentary switch or the start of a subsequent hand. The preferred embodiment for “commission” games in California is the payment of the commission (e.g., as detected by the chip monitor implemented in an instrumented drop box).

In FIG. 5, at 502 the system transitions to the new game state (NG). A “new game” can be triggered by a number of events including (but not limited to) dealing the first card of a hand, placement of bets, or the pressing of a momentary switch. The preferred embodiment for “commission” games in California is two-fold: (1) dropping the commission into the drop box ends one game and starts the next—unless no cards are dealt within a specified time window, and (2) if the time window is exceeded, drawing a card starts a new game.

At 504, a bet is placed at a betting spot. The system detects the tokens, as indicated by the rise to the “bet” line on the y-axis. At 506, the first card is dealt; the system detects this and transitions to the bets locked (BL) state. (The game play occurs during the BL state, with the dealer dealing cards and the system transitioning through the states, for example as shown in FIGS. 7-9.) At 508, additional tokens are placed on the betting spot, which the system detects and generates an alert. At 510, the excess tokens (from 508) are removed; with the game play concluded and the correct bets in place, the system transitions to the payout (PO) state. As a result of the game play, the bet shown in FIG. 5 is a winner. At 512, the dealer pays out the winnings in a first portion, and at 514 pays out the second portion, which the system detects. The system is aware of the game results and the correct payout amount, as indicated by the “payout for win” line on the y-axis. At 516, the system detects that the amount of tokens on the spot exceeds the correct payout amount (e.g., the dealer has paid out too much), and the system generates an alert. At 518, the system detects that the excess tokens have been removed. At 520, the system detects a lower amount of tokens, for example resulting from a player removing some of the winnings but leaving some tokens for the next game. At 522, the system transitions to the end of game (EG) state. At 524, the system transitions to the new game (NG) state for the next game (e.g., the system detects the commission tokens have been dropped).

In FIG. 6, at 602 the system transitions to the new game state (NG). At 604, a bet is placed at a different betting spot than the one related to FIG. 5. At 606, the first card is dealt; the system detects this and transitions to the bets locked (BL) state. At 608, as a result of the game play, the system transitions to the payout (PO) state, and the system knows that the bet is a losing bet. At 610, the system detects that the dealer collects a first portion of the losing bet, and at 612 detects that the dealer collects the remaining portion. At 614, the system transitions to the end of game (EG) state. At 616, the system detects that a new bet is placed for the next game. At 618, the system transitions to the new game (NG) state for the next game (e.g., the system detects the commission tokens have been dropped).

In comparing FIG. 5 and FIG. 6, note how the system can detect and account for payout and collection rules (e.g., as stored in the game rule database 114 of FIG. 1). For example, for a rule that losing bets are to be collected before winning bets are paid, this corresponds to 610 and 612 being completed before 512 and 514 are performed. If this does not occur, the system detects it and generates an alert.

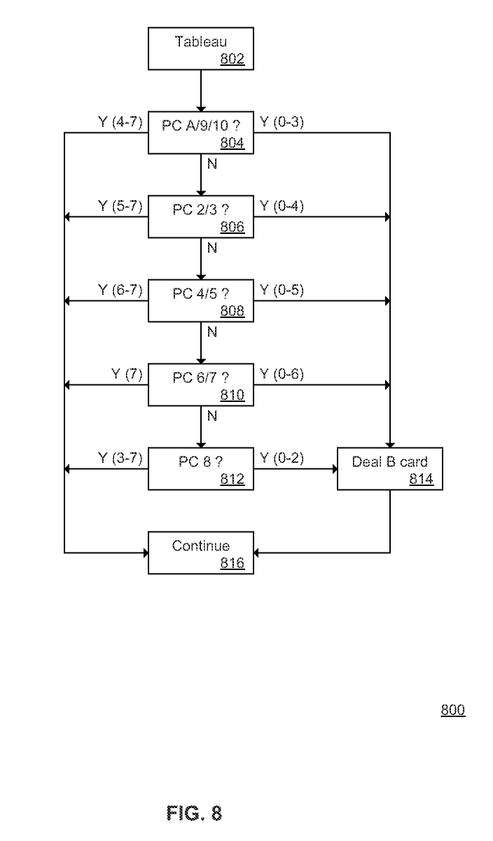

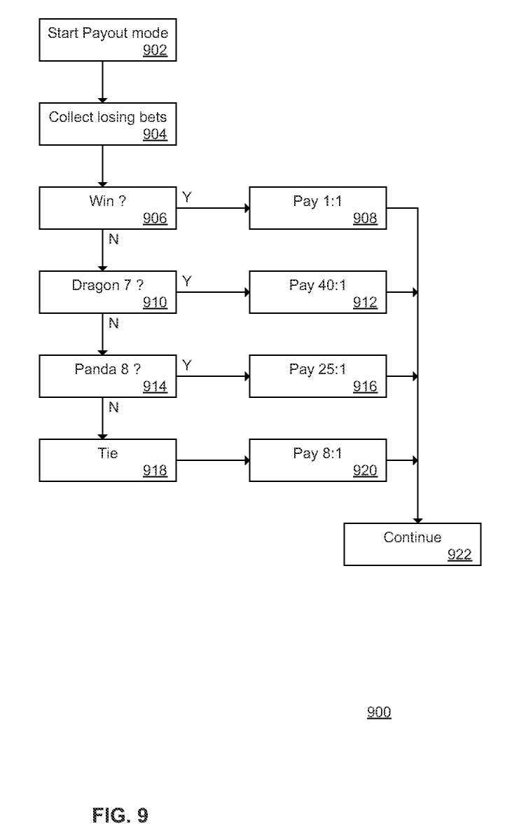

FIGS. 7-9 show basic flow diagrams for Baccarat. FIG. 7A shows an overall flow diagram 700 for EZ Baccarat. FIG. 7B shows an overall flow diagram 750 for punto banco Baccarat. FIG. 8 shows a detailed flow diagram for the Tableau box 800 of FIGS. 7A-7B. FIG. 9 shows a detailed flow diagram for the Payout box 900 of FIG. 7A. In general, FIGS. 7-9 show the game states, the transitions from one state to the next, when a player or banker is dealt a 3rd card, how winners and losers are identified, how the special case of “EZ” is used to manage the odds, and how payouts are calculated. The system transitions among the various states by detecting that cards are dealt, by identifying the cards, by calculating the totals, and by applying the game rules (e.g., using a game result monitor such as the card reader device 244 of FIG. 2 or the OCR component 344 of FIG. 3, and the game rule database 114 of FIG. 1).

In FIG. 7A (EZ Baccarat), the system starts in the new game state 702. At 704, a first card is dealt to a player. The system detects this, which causes the system to transition from the new game state to the bets locked state.

At 706, a first card is dealt to the banker, a second card is dealt to the player, and the second card is dealt to the banker. At 708, if the player's or banker's total is 8 or 9, the system goes to 720; if not, the system goes to 710. At 710, if the player's total is 6 or 7, the system goes to 714; if not, the system goes to 712. At 712, the player is dealt a card, and the system goes to the Tableau box 800 (see FIG. 8). At 714, if the banker's total is 6 or 7, the system goes to 720; if not, the system goes to 716. At 716, the banker is dealt a card, and the system goes to 720. At this point, the system knows no more cards are to be dealt and that the winner may be determined, and so transitions to the payout mode.

At 720, if the banker wins (e.g., the banker's total exceeds the player's total), the system goes to 722; if not, the system goes to 726. At 722, the special situation of “EZ” is addressed. When the banker has a 3-card total of 7 (see above regarding description of EZ Baccarat) this is the “Dragon 7” result, and the system goes to 724. When the banker does not have the “Dragon 7”, the system goes to 726. At 724, the system verifies that the dealer correctly implements a push (since as described above, when the dealer wins (see 720) with Dragon 7 (see 722) the result is a push). At 726, if the player wins (e.g., the player's total exceeds the banker's total), the system goes to the Payout box 900; if not, the system goes to 728. At 728, the system determines that there is a tie, and goes to the Payout box 900. After the Payout 900 or the Push 724, the system goes to the next game 730 (e.g., back to the new game 702). The system may verify that the commission amount is correct and that the commission has been collected before going to the next game.

In FIG. 7B (punto banco Baccarat), the system starts in the new game state 752. At 754, a first card is dealt to a player. The system detects this, which causes the system to transition from the new game state to the bets locked state.

At 756, a first card is dealt to the banker, a second card is dealt to the player, and the second card is dealt to the banker. At 758, if the player's or banker's total is 8 or 9, the system goes to 768; if not, the system goes to 760. At 760, if the player's total is 6 or 7, the system goes to 764; if not, the system goes to 762. At 762, the player is dealt a card, and the system goes to the Tableau box 800 (see FIG. 8). At 764, if the banker's total is 6 or 7, the system goes to 768; if not, the system goes to 766. At 766, the banker is dealt a card, and the system goes to 768. At this point, the system knows no more cards are to be dealt and that the winner may be determined, and so transitions to the payout mode.

At 768, the system verifies that the dealer collects the losing bets correctly. The system knows which bets lose (since it knows the results of the game according to the game result data 124 and according to the game rules in the game rule database 114 of FIG. 1), and detects the chips being removed (according to the chip data 122). The system may monitor that the dealer removes the losing bets in a defined order (e.g., from rightmost seated player position 7 to left, ending with seated player position 1), according to the event monitoring program 110, and may generate alerts (e.g., out of order removal alert) when this defined order is not followed.

At 770, if the banker wins (e.g., the banker's total exceeds the player's total), the system goes to 790; if not, the system goes to 776. At 776, if the player wins (e.g., the player's total exceeds the banker's total), the system goes to 792; if not, the system goes to 778. At 778, the system determines that there is a tie, and goes to 794. At 790, the system verifies that the dealer correctly pays out the winning bets on the banker at 0.95-to-1, as per the Punto Banco Baccarat description above, and goes to 796. At 792, the system verifies that the dealer correctly pays out the winning bets on the player at 1-to-1, and goes to 796. At 794, the system verifies that the dealer correctly pays out the winning bets on the tie at 8-to-1, and goes to 796. At 796, the system goes to the next game (e.g., back to the new game 752). The system may verify that the commission amount is correct and that the commission has been collected before going to the next game.

In FIG. 8, the system begins in the Tableau start box 802. At 804, if the card dealt to the player at 712 (see FIG. 7A, or 762 in FIG. 7B) was an ace, nine or ten, and the player's total is 4-7, the banker stands and the system goes to the continue box 816. If the card dealt to the player at 712 was an ace, nine or ten, and the player's total is 0-3, the system goes to 814. If the card dealt to the player at 712 was not an ace, nine or ten, the system goes to 806.

At 806, if the card dealt to the player at 712 (see FIG. 7A, or 762 in FIG. 7B) was a two or three, and the player's total is 5-7, the banker stands and the system goes to the continue box 816. If the card dealt to the player at 712 was a two or three, and the player's total is 0-4, the system goes to 814. If the card dealt to the player at 712 was not a two or three, the system goes to 808.

At 808, if the card dealt to the player at 712 (see FIG. 7A, or 762 in FIG. 7B) was a four or five, and the player's total is 6-7, the banker stands and the system goes to the continue box 816. If the card dealt to the player at 712 was a four or five, and the player's total is 0-5, the system goes to 814. If the card dealt to the player at 712 was not a four or five, the system goes to 810.

At 810, if the card dealt to the player at 712 (see FIG. 7A, or 762 in FIG. 7B) was a six or seven, and the player's total is 7, the banker stands and the system goes to the continue box 816. If the card dealt to the player at 712 was a six or seven, and the player's total is 0-6, the system goes to 814. If the card dealt to the player at 712 was not a six or seven, the system goes to 812.

At 812, the card dealt to the player at 712 (see FIG. 7A, or 762 in FIG. 7B) was an eight (by process of elimination from passing through the previous steps). If the player's total is 3-7, the banker stands and the system goes to the continue box 816. If the player's total is 0-2, the system goes to 814.

At 814, the dealer deals a card to the banker, and the system goes to the continue box 816. At 816, the system returns to the Tableau box 800 (see FIG. 7A or FIG. 7B).

In FIG. 9, the system begins in the Payout start box 902. At 904, the system verifies that the dealer collects the losing bets correctly. The system knows which bets lose (since it knows the results of the game according to the game result data 124 and according to the game rules in the game rule database 114 of FIG. 1), and detects the chips being removed (according to the chip data 122). The system may monitor that the dealer removes the losing bets in a defined order (e.g., from rightmost seated player position 7 to left, ending with seated player position 1), according to the event monitoring program 110, and may generate alerts (e.g., out of order removal alert) when this defined order is not followed.

At 906, if either the player or the banker is the winner (e.g., whoever has the larger total), the system goes to 908; otherwise the system goes to 910. At 908, the system verifies that the dealer pays out the winning bets at 1-to-1, and goes to 922. At 910, if the banker total is 7 (“dragon”), then dragon side bets are winners, and the system goes to 912; if not, the system goes to 914. At 912, the system verifies that the dealer pays the dragon bet winners at 40-to-1, and the system goes to 922. At 914, if the banker total is 8 (“panda”), then panda side bets are winners, and the system goes to 916; if not, the system goes to 918. At 916, the system verifies that the dealer pays the panda bet winners at 25-to-1, and the system goes to 922. At 918, if there is a tie, the system goes to 920. At 920, the system verifies that the dealer pays tie bets at 8-to-1, and the system goes to 922.

At 922, the system may monitor that the dealer pays the winning bets in a defined order (e.g., from rightmost seated player position 7 to left, ending with seated player position 1), according to the event monitoring program 110, and may generate alerts (e.g., out of order payout alert) when this defined order is not followed. For example, the system verifies that the dealer starts with seated player position 7, and loops through 906-918 until all the winning bets for seated player position 7 have been paid; then the system verifies that the same is done for seated player position 6, then for seated player position 5, etc. The system then returns to the Payout box 900 in FIG. 7A.

FIGS. 10-14 show examples of screen layouts generated by the casino monitoring system (e.g., as the combined output 130 of FIG. 1), using Baccarat as an example implementation. These figures illustrate how the system is focused on the ability to create specific time-stamped alerts, each with a defined (and generally identifiable) root cause or trigger.

FIG. 10 is a screen layout for the pre-game state. Key features include a personnel identification (ID) area 1002, a game state indicator area 1004, date and time stamp areas 1006 and 1008, a timer area 1010, a card display area 1012, a table action area 1014, a commission area 1016, a net cash area 1018, a games per hour area 1020, a video area 1022, a bets grid area 1024, alerts areas 1026 and 1028, betting position summary areas 1032, and table identification area 1034.

The personnel ID area 1002 displays the dealer ID of the dealer dealing the game being monitored, and the floor ID of the floor manager. The floor manager generally manages a number of dealers and other gaming personnel. Further details regarding the dealer ID and floor ID are provided below.

The game state indicator area 1004 displays the game state (e.g., pre-game, new game, bet mode, bets locked mode, payout mode, etc.). The date stamp area 1006 shows the date stamp of the information being displayed, and the time stamp area 1008 shows the time stamp of the information being displayed. When the combined output of FIG. 10 is being viewed contemporaneously with the action being monitored, the date stamp will be the current date and the time stamp will be the current time. When the combined output is being viewed at a later date, the date stamp and time stamp information may be used to select and to view the action at a particular time in the past.

The timer area 1010 displays a timer. The timer shows the duration of each game (e.g., starting at zero in bet mode or new game mode, and ending when payout mode is completed). The card display area 1012 displays the cards having been identified by the game result monitor (e.g., the card reader device 244 of FIG. 2 or the OCR component 344 of FIG. 3). The card display area 1012 may include a dealer card area for showing the three (potential) dealer cards and a player card area for showing the three (potential) player cards. Note that the cards displayed are graphic representations of the actual cards as identified by the card monitor; the actual cards themselves may also be seen in the video displayed in video area 1022. The card display area 1012 may also display the respective totals for the player and banker (e.g., as detected by the game result monitor). In the pre-game state, the card display area 1012 may show representations of card backs (as shown in FIG. 10), or may show blank areas that are filled in as cards are dealt (in later states).

The table action area 1014 displays data indicating the amount of money in play at the table. The table action may be displayed on a per-game and a per-session basis. (A session may correspond to a dealer shift, a 30-minute increment, etc.; a session includes multiple games played.) For example, the table action data is generated by the system 100 (see FIG. 1) reading the chip data 122 and calculating the total value according to the chip database 112. In general, the table action is the sum of all bets detected at the table (which are themselves individually displayed in the bets grid area 1024, as further discussed below).

The commission area 1016 displays the game commission information. The game commission information may be displayed as a per-game amount and as a running total that is reset to zero each time the drop box is removed and replaced. For example, the commission may be calculated based on a defined schedule and the amount of table action (which the system can detect, as discussed above regarding 1014).

The net cash area 1018 displays the net cash in and out of the game. In general, this corresponds to the intake and outlay from the dealer tray, except in jurisdictions where the house does not have an interest in the outcome (e.g., California). The net information may be displayed on a per-game and a per-session basis.

The games per hour area 1020 displays an estimate of the number of games per hour. This estimate may be calculated by counting the number of games completed in a session times the number of sessions in an hour. For example, if 3 games are completed in a 6-minute session (360 seconds), there are 10 sessions per hour, so the estimate is 30 games per hour.

The video area 1022 displays the video data 120 (see FIG. 1). Casino personnel may monitor the video area 1022 concurrently with watching the bets displayed in the bets grid area 1024 and watching for any alerts displayed in the alerts area 1026, providing greatly enhanced monitoring ability.

The bets grid area 1024 displays the bets made at the gaming table. The bets grid area 1024 is configured for EZ Baccarat. In EZ Baccarat, there are seven seated bettor positions (labeled seats 1-7). Each seated bettor position has four betting zones. EZ Baccarat has five possible bets: player win, banker win, tie, panda, and dragon. Thus, the bets grid area 1024 displays bets detected at 140 potential betting locations on the gaming table. In general, each grid square displays the number of tokens (e.g., as detected by the chip reader device 242 of FIG. 2 or FIG. 3) and the value of those tokens (e.g., as calculated by the system 100 by accessing the chip database 112 using the identifiers of the tokens detected).

The configuration of the bets grid area 1024 may be adjusted as desired to accommodate other gaming variations. The number of betting zones may be increased or decreased. For example, when the betting limit is $200, having four betting zones effectively increases the betting limit to $800. The type of bets may be adjusted. For example, punto banco Baccarat has three possible bets (player win, banker win, and tie).

The seven alert areas 1026 are respectively associated with the seven seated bettor positions and display alerts associated with each position. The alerts displayed in the alert areas 1026 include an illegal chip alert, a late bet alert, a change in winning row alert, an over payout alert, an under payout alert, an out of order payment alert, and out of order loser removal alert, and a payout error alert. The illegal chip alert is generated when the system detects a chip on the table that is not in the chip database 112 (or that is flagged in the chip database 112 as being illegal, etc.). The late bet alert is generated when the system detects a bet when the game state is other than a state in which bets are allowed (e.g., a bet occurring in the bets locked mode). The change in winning row alert is generated when the system detects chips moving from one row (e.g., a player win bet on the bets grid area 1024) to another row (e.g., a dealer win bet), when such a move is not allowed (e.g., in the bets locked mode). The over payout alert is generated when the system detects that the dealer pays out in excess of the correct payout amount (see, e.g., 516 in FIG. 5). The under payout alert is generated when the system detects that the dealer pays out less than the correct payout amount. The out of order payment alert is generated when the system detects that the dealer pays out in an abnormal order (e.g., if the normal payout order is left to right, and the dealer pays right to left; or vice versa). The out of order loser removal alert is generated when the system detects that the dealer removes losing bets in an abnormal order (e.g., if the normal removal order is left to right, and the dealer removes from right to left; or vice versa). The payout error alert is generated when the system detects that the dealer makes a payout to an incorrect location or of an incorrect amount.

The alert area 1028 displays alerts that are more generally applicable. The alerts displayed in the alert area 1028 include an extra card draw alert, an abnormal termination alert, an incorrect commission alert, and an all losers removed alert. The extra card draw alert is generated when the system detects that the dealer has dealt a third card for the player or dealer in an incorrect situation (e.g., other than as authorized according to the states 712 or 716 in FIG. 7, as determined according to the game rule database 114 and the game result data 124 of FIG. 1). The abnormal termination alert is generated when the system detects that the dealer drops the house commission into the drop slot prior to collecting all losing bets and paying out all winning bets. The incorrect commission alert is generated when the system detects that the dealer has miscalculated the commission (e.g., the dealer removes the collection from the table action and places it in a collection area, which the system detects and compares to what the actual commission should be according to the commission schedule and the data detected). The all losers removed alert is generated when the system detects that the dealer has failed to remove all the losing bets (e.g., the system is aware of the outcome of the game and thus knows a particular bet is a loser, and detects that the dealer fails to remove it at the appropriate time according to the game state).

More details regarding alerts are provided in subsequent sections.

As an example of the information that may be displayed in FIG. 10, consider the following bets displayed the bets grid area 1024 (also reproduced in TABLE 1 below): for seated player position 1, 1 token of value $5, bet for player win, in the fourth zone for that seat; also for seated player position 1, 1 token of value $5, bet for dragon, in the fourth zone for that seat; for seated player position 2, 1 token of value $5, bet for banker win, in the first zone for that seat; also for seated player position 2, 1 token of value $25, bet for panda, in the fourth zone for that seat; for seated player position 3, 1 token of value $25, bet for tie, in the first zone for that seat; for seated player position 4, 1 token of value $25, bet for panda, in the fourth zone for that seat; also for seated player position 4, 1 token of value $25, bet for dragon, in the fourth zone for that seat; for seated player position 5, 1 token of value $25, bet for tie, in the first zone for that seat; also for seated player position 5, 1 token of value $25, bet for panda, in the first zone for that seat; for seated player position 6, 1 token of value $25, bet for banker win, in the first zone for that seat; also for seated player position 6, 1 token of value $25, bet for tie, in the first zone for that seat; for seated player position 7, 1 token of value $25, bet for player win, in the first zone for that seat; and also for seated player position 7, 1 token of value $25, bet for banker win, in the first zone for that seat. The system may display these bets in the form “X1, X2” in each grid square, where X1 is the number of tokens, X2 is the total value, and the comma represents the information being displayed on separate lines. In the grid squares with no bets, the system may display “0, $0”, signifying zero tokens detected and $0 total bet. Thus, the system has detected $265 total (which it displays in the table action area 1014); according to the commission schedule the system calculates a commission of $2 (which it displays in the commission area 1016).

TABLE 1

| Position | Bet | Tokens, Amount |
|---|---|---|
| 1 | Player win | 1, $5 |
| 1 | Dragon | 1, $5 |
| 2 | Banker win | 1, $5 |
| 2 | Panda | 1, $25 |
| 3 | Tie | 1, $25 |
| 4 | Panda | 1, $25 |
| 4 | Dragon | 1, $25 |
| 5 | Tie | 1, $25 |
| 5 | Panda | 1, $25 |
| 6 | Banker win | 1, $25 |
| 6 | Tie | 1, $25 |
| 7 | Player win | 1, $25 |
| 7 | Banker win | 1, $25 |

Note that in pre-game and new game modes, the system may be configured such that the only alert displayed is the illegal chip alert. As an example, consider that an illegal token is placed for a dragon bet in the first betting zone 1030 for player 7; the system may generate this alert by displaying a blinking box in the zone 1030 on the bets grid area 1024 (shown as hashing in the figure). In such a situation, the system may display the number of tokens detected in that zone (e.g., 1 illegal token) and the value (e.g., $0 since the token is illegal).

The betting position summary areas 1032 display summaries of the bets placed for the seven seated player positions (e.g., the information displayed in the bets grid area 1024, summarized by player position). For example using the information in TABLE 1, for seated player position 1, the corresponding summary area 1032 shows 2 total tokens and $10 total value; for seated player position 2, the corresponding summary area 1032 shows 2 total tokens and $30 total value; for seated player position 3, the corresponding summary area 1032 shows 1 total token and $25 total value; for seated player position 4, the corresponding summary area 1032 shows 2 total tokens and $50 total value; for seated player position 5, the corresponding summary area 1032 shows 2 total tokens and $50 total value; for seated player position 6, the corresponding summary area 1032 shows 2 total tokens and $50 total value; for seated player position 7, the corresponding summary area 1032 shows 3 total tokens and $50 total value (e.g., the illegal token is included in the token count, but being illegal it is not included in the total value).

The table identification area 1034 displays a table identifier for the gaming table that corresponds to the information displayed on the screen layout. The table identification area 1034 may also display a facility identifier. In general, a facility will have a number of gaming tables. The table identifier and the facility identifier may be programmed by a system administrator. The gaming table may transmit the table identifier to the system along with the video data 120, chip data 122 and game result data 124 (see FIG. 1).

The screen layout may include other information as desired. For example, the gaming table may include a dedicated payout area for paying out large bets such as panda or dragon. The gaming table will include an antenna to read the tokens placed in this area. The screen layout may then display the number and value of the tokens in the payout area, for verification purposes.

As another example, the screen layout may display other status information about the game or the gaming table. This information may include whether the drop box is removed; whether a burn is in progress; whether the dealer should use a new card shoe after the current hand; whether the dealer should use a new card shoe immediately; whether the current hand is a free hand; and whether the system has detected an illegal bet during a free hand.

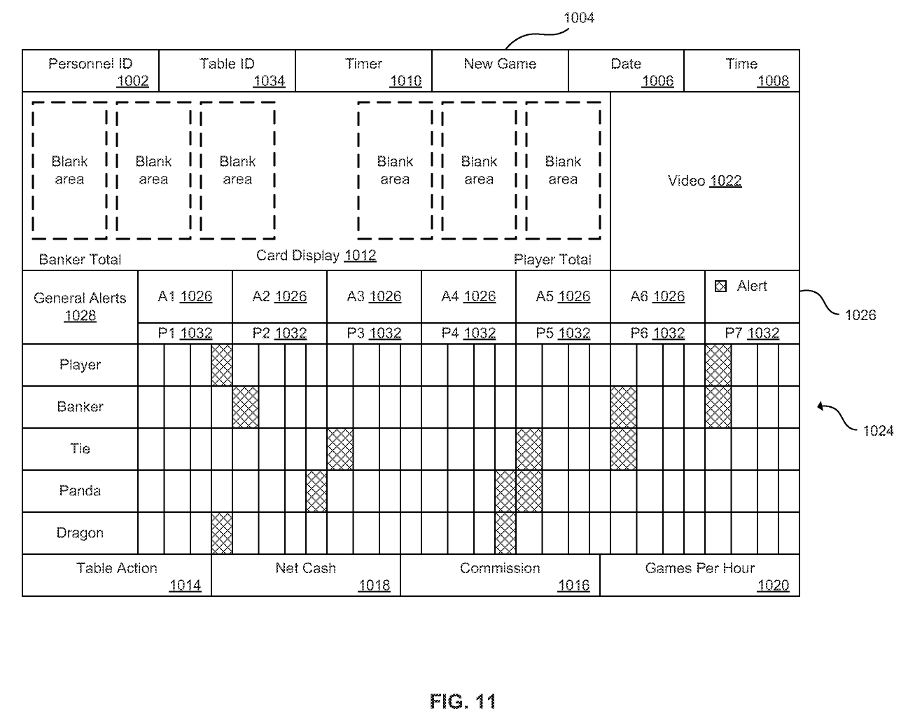

FIG. 11 is a screen layout for the bets state (also referred to as the bets allowed state or the new game state). Most of the features of FIG. 11 are similar to those in FIG. 10 and are labeled similarly. In general, the system transitions to the new game state (FIG. 11) after the previous game has ended. When there was no previous game, the system transitions to the new game state (FIG. 11) from the pre-game state (FIG. 10) according to a detected event, such as the game result monitor detecting a game result (e.g., the first card being dealt from the shoe) or the system detecting a button press by the dealer. (Note that the bettors place bets without any knowledge of the cards, so any cards are dealt face down.) The transition from the pre-game state may also start the synchronized video recording as displayed in the video area 1022, if it is not already going.

During the “bets allowed” state, players can freely place and move bets; thus, the bets grid area 1024 shows the bet information according to the “X1, X2” format described above, as the bets are placed and moved among the grid squares. In FIG. 11, the bets of TABLE 1 are shown as cross-hatched squares in the bets grid area 1024. Certain alerts may persist in the display. For example, in FIG. 11 the illegal token (cf. 1030 in FIG. 10) has been removed from the table, and hence is no longer displayed in the bets grid area 1024 (cf. 1030 in FIG. 10); and the illegal token is no longer counted in the betting position summary area 1032. However, the alerts area 1026 above betting position 7 may continue to display the alert for historical monitoring purposes.

The other differences from FIG. 10 to FIG. 11 are as follows. The timer area 1010 displays the elapsed time of the current game. The game state indicator area 1004 displays the game state of “new game” (or “bet”). The time stamp area 1008 displays the current time stamp. The video area 1022 displays the video data concurrent with the table actions. The card display area 1012 shows blank areas (or alternatively, card backs as in FIG. 10) for the cards to be dealt in future states.

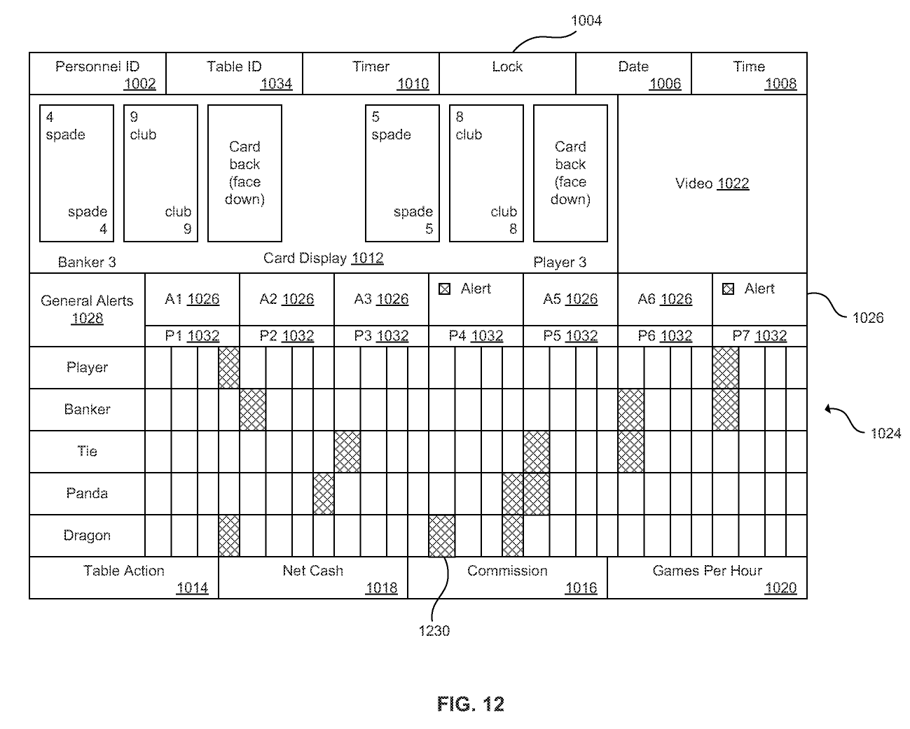

FIG. 12 is a screen layout for the bets locked state. Most of the features of FIG. 12 are similar to those in FIGS. 10-11 and are labeled similarly. The system transitions from the new game state (FIG. 11) to the bets locked state (FIG. 12) when the dealer deals the first card (e.g., as detected by the game result monitor). See also 704 in FIG. 7A. Alternatively, the system transitions to the bets locked state when the dealer deals the second card, or the fourth card. As another option, the system transitions to the bets locked state when the game result monitor detects a game result identifier (e.g., when a card has been turned face-up, the card monitor reads its rank information as the game result identifier.) During this state, the house commission (based on the schedule selected at the outset of the session) is calculated. As an example of an alert, the hashed box 1230 shows a late Dragon bet of $25 was introduced by Player 4. The dealer can then instruct the player to remove the late bet.

The differences from FIG. 11 to FIG. 12 are as follows. The game state area 1004 shows “lock” as the current game state. The card display area 1012 displays the cards as they are detected by the game result monitor according to the gameplay (e.g., until the game is over according to the game states of FIGS. 7-8). In the example shown, the game is not yet complete, with the banker total 3 and the player total 3 and one card remaining for each. The table action area 1014 displays the table action (e.g., $290 when the late bet has been detected, $265 when it has been removed). The commission area 1016 displays the commission calculated according to the relevant schedule (e.g., $2). The commission area 1016 may display three numbers. The first number is the commission that the system calculates for the current game based on the table action and the collection schedule. The second number is the actual commission collected, as detected by the drop box reader. The third number is the cumulative commission total, which may be reset when a designated event occurs. A common event is the removal of the drop box, which the system may detect according to an antenna in the gaming table and an RFID tag on the drop box. The system may thus associate the cumulative commission total (third number) with the drop box, for casino personnel to verify when the tokens from the drop box are counted in the casino's count room. The alerts area 1026 for position 4 shows the late bet alert. The betting position summary area 1032 for position 4 shows the total of 3 tokens with $75 total value when the late bet has been detected, and 2 tokens with $50 total value when it has been removed. The hashed boxes in the bets grid area 1024 (other than the illegal bet 1230) show the locked bets (according to the example bets discussed in TABLE 1 for FIGS. 10-11). The information in the bets grid area 1024 may be updated to show three pieces of information in the format “X1, X2, X3” (e.g., $10, 2, $10), where X1 is the locked total value, X2 is the currently-detected number of tokens, and X3 is the currently-detected total value, where the commas represent the information being displayed on separate lines. (Due to size constraints, the three pieces of information are not shown in the grid squares.) The timer area 1010, the time stamp area 1008 and the video area 1022 continue to displays the elapsed time, the current time stamp and the current video data.

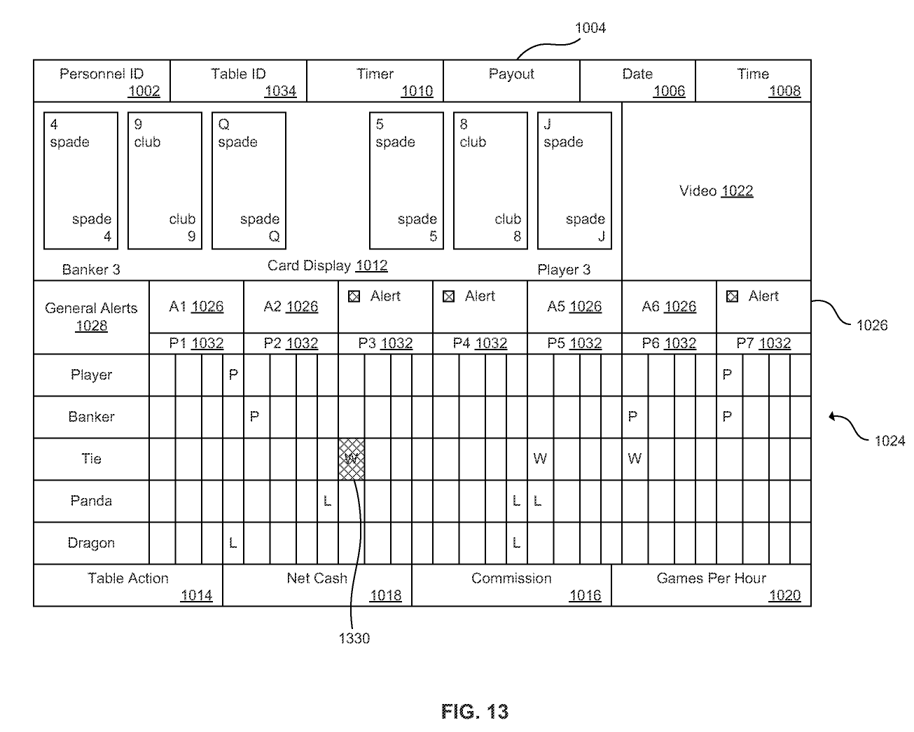

FIG. 13 is a screen layout for the payout state. Most of the features of FIG. 13 are similar to those in FIGS. 10-12 and are labeled similarly. The system transitions from the bets locked state (FIG. 12) to the payout state (FIG. 13) when the deal is complete (e.g., as determined by the event monitoring system 100 of FIG. 1 by moving through the game states of FIG. 7A or 7B and 8 using the game result data 124 provided by the game result monitor). During this state, the dealer performs the collections and payouts (see FIGS. 7B and 9).

The differences from FIG. 12 to FIG. 13 are as follows. The game state area 1004 shows “payout” as the current game state. The card display area 1012 shows that the banker has 4, 9, Q (total 3) and the player has 5, 8, J (total 3); thus the system knows there is a tie. The bets grid area 1024 displays “P” for bets that push (e.g., when there is a tie, bets for banker win and player win both push), “W” for bets in the winning grid squares, and “L” for bets in the losing grid squares, as determined by the system. As an example of an alert, the grid square 1330 shows an alert for a change in the winning row; e.g., the player at position 3 added an extra $25 token as a bet for the tie. The system displays this as “$25, 2, $50” in the grid square so that the bets-locked bet amount ($25) may be compared to the currently-detected bet amount ($50), and the number of tokens (2) may be reviewed. In response to this alert, the table action area 1014 shows “$290, $265” as another indication of the illegal bet, and the alerts area 1026 for position 3 displays the alert “change in winning row”. In response to the alert, the dealer can instruct the player to remove the illegal bet, and the system causes the bets grid area 1024 to update accordingly. (The alerts area 1026 for position 4 may continue to display the “late bet” alert from FIG. 12, and for position 7 may continue to display the “illegal chip” alert from FIG. 10, for historical monitoring purposes.)

Once the dealer determines that the action is correct (e.g., the illegal bet has been removed), the dealer collects the losing bets and pays out the winning bets. For push bets, the players may leave them or move them as they wish for the next game. The system may generate alerts to conform the dealer to set collection and payout procedures. For example, the system may generate an alert when the dealer fails to collect all the losing bets before paying out a winning bet. This is called an “all losers removed” alert and may be displayed in the alerts area 1028. As another example, the system may generate an alert when the dealer fails to collect, or pay out, in a defined order. This is called an “out of order collection” (or “out of order payout”) alert and may be displayed in the alert area 1026 corresponding to the position of the incorrect collection (or payout). The defined order may be right-to-left, such that the dealer is supposed to collect all losers from seated position 7, then from seated position 6, etc.; a similar order may be defined for payouts.

The net cash area 1018 displays the results of the collections and payouts (e.g., −$495 using the bets and results discussed above). The timer area 1010, the time stamp area 1008 and the video area 1022 continue to display the elapsed time, the current time stamp and the current video data.

Finally, dropping the house commission tokens into the drop box (or other collection receptacle) triggers the end of a game. The area in which the collection tokens are detected may be referred to as the read area of the drop box. The system may detect these tokens using the chip monitor (e.g., the chip reader device 242 of FIG. 2); for example, by using an antenna in the neck of the drop box to detect the tokens passing through the neck, by using an antenna integrated into the guillotine slider that covers the drop hole into the drop box, etc. They system may use other ways to detect dropping the commission or otherwise signaling the end of game. As one example, the guillotine may include a switch, which the gaming table monitors and sends to the system when the dealer slides the guillotine. As another example, the gaming table may include a switch that the dealer triggers manually to signal the end of game. The gaming table monitors the switch and sends its data to the system with the other data the gaming table is generating (e.g., the chip data, card data, video data, etc.).

Once the game has ended, the system may continue to display the status of the game for several seconds so that this image can be easily reviewed on playback.

Example of Alarms

One of the features of an RFID-enabled gaming table is the ability to detect incorrect play. Ideally, these errors (or attempts at cheating) can be rectified “in the moment” by providing the alerts to the dealer. Or they can be reviewed after the fact using the “review” application discussed in more detail below. These alerts may be displayed in the alerts areas 1026 (see FIG. 10).

The following alarms are supported by the system described above:

1. Illegal chip. This alarm is triggered any time that the system reads an RFID tag that is not registered in the chip database (e.g., the chip database 112 of FIG. 1). FIG. 10 shows an example of the illegal chip alert.

2. Late bet. Once the system is in bets locked mode, any additional bets will trigger this alarm. This alarm is dynamic during bets locked mode and becomes static if the error is not rectified prior to entering the payout mode. See below for a description of “static” versus “dynamic” alarms. FIG. 12 shows an example of the late bet alert.

3. Changes to any winning bet. Once a hand has been dealt and winners and losers identified, the system enters payout mode. During the payout mode, it is important to capture any attempts to alter the bets placed on a winning spot. This alarm is dynamic in payout mode and becomes static if the error remains when the commission is collected at the end of the game. FIG. 13 shows an example of the change to winning bet alert (also referred to as the change to winning row alert).

4. Over pay. This alarm is set anytime the payout is greater than the expected amount. This alarm is dynamic and will become static if one of the following two events occurs:
the player removes his winnings without a correct payout, or
the commission is collected without a correct payout.

5. Under pay. This alarm is set anytime the payout is less than the expected amount. This alarm behaves similarly to the over pay alert.

6. Out-of-order collection (removal of losing bets). The system tracks the removal of bets from the dealer's right-to-left (e.g., as detected by the chip monitor such as the chip reader device 242 of FIG. 2). This alarm is set if the dealer does not follow this right-to-left sequence. For example, the system detects whether the dealer collects all the losing bets from seated player position 7 (see FIG. 13), then from seated player position 6, etc. Alternatively, the system may be configured to generate an alert when the dealer fails to follow a left-to-right sequence.

7. Out-of-order payment. The system tracks the payout from the dealer's right-to-left. This alarm is set if the dealer does not follow this right-to-left sequence. Alternatively, the system may be configured to generate an alert when the dealer fails to follow a left-to-right sequence.

8. Payout error. This alarm is set if payouts are made to incorrect locations or prior to the removal of all losing bets.

9. Extra card draw. This alarm is set if the dealer draws additional cards during a game.

10. Incorrect commission. This alarm is set if the dealer does not accurately calculate the house commission. The calculation of the house commission is based on the selected commission schedule.

11. Abnormal termination. This alarm is set if the dealer drops the house commission into the drop slot prior to collecting all losing bets and paying out all winning bets.

12. All losers removed. This alarm is set if the dealer fails to collect all the losing bets before paying the first winning bet.

13. Capped bet. This alarm is set if the system detects the player has “capped” a bet. A capped bet is a subset of the “change in winning bet”, in which a bettor places an additional bet on top of an existing winning bet, outside of the allowed time for placing bets.

Note that the alerts for extra card draw, incorrect termination, and abnormal termination are not related to a specific player position, and thus may be displayed in the alerts area 1028 (see FIG. 10) instead of the alert areas 1026 related to the player positions.

One embodiment uses both “dynamic” and “static” alarms. Dynamic alarms display only the current status. This allows corrective actions to be taken to rectify the error. If corrective action has not been taken prior to a change in game state, it becomes a static alarm.

Each alarm type has different value to different stakeholders (e.g., dealer, floor, security, management). According to other embodiments, additional alarms may be implemented for both Baccarat or for other table games.

Game Summary Mode

One embodiment implements functionality to summarize the key elements of each completed game (or completed hand). This summary may include one or more of the following data: the date/time of each hand, the dealer responsible for each hand, the total bets placed on a given hand, the name of each player corresponding to each bet, the net wins/losses of a specific game, the aggregate wins/losses during a specific time interval (e.g. during a dealer's shift), the speed of play (hands per hour), and the number/type of any alarms.

The system may use this summary information to populate the following databases: dealer metrics, player profiles, and table/game metrics. The system may store these metrics in databases stored by the storage 104 (see FIG. 1). In addition, casino personnel may use the system to search this data and select individual games for subsequent review.

Game Review Mode

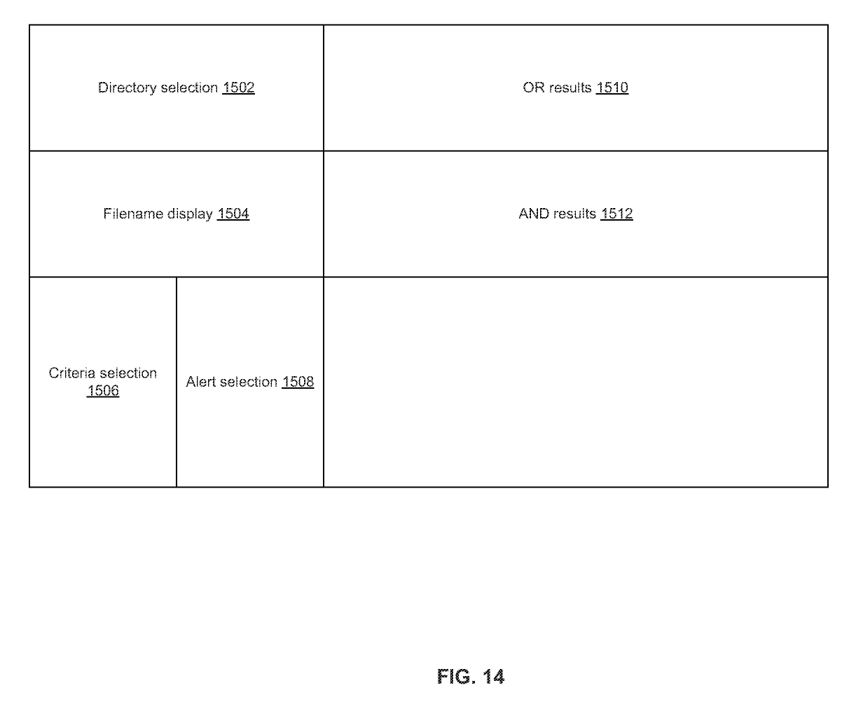

FIG. 14 shows an example of a game review screen 1500. The game review screen 1500 allows casino personnel to review the stored game data (e.g., as stored in the other databases 116 of FIG. 1). One embodiment implements functionality to review individual games selected using one or more of the following criteria: date/time windows (start date/time to end date/time), dealer ID, range of commission amount, range of net amount wagered, and one or more specific alarm conditions. More specifically, the game review screen 1500 includes a directory selection area 1502, a filename display area 1504, a criteria selection area 1506, an alert selection area 1508, an OR results area 1510, and an AND results area 1512.

The directory selection area 1502 provides a graphical interface to the system's storage (e.g., the storage 104 in FIG. 1) where the game results, alarms, and other information detected by the gaming table (e.g., the video data 120, the chip data 122, the game result data 124, the combined output 130, etc.) are stored. The user may maneuver through the file system and may select a directory containing the stored output. The filename display area 1504 displays the filenames of the stored game results in the selected directory. In one embodiment the stored game results are stored as CSV (comma separated value) data that excludes the video data; the system then uses the timestamps to synchronize the stored game results and the corresponding video data.

The criteria selection area 1506 provides a graphical interface for the user to specify the criteria that the system is to use in searching the stored game results. Selectable criteria include any of the data sent by the gaming table, including the date and time information, the table number, the commission amount, the house net, the dealer name, etc. The user may specify each criterion by using a check box, then for a specified criterion, start and end ranges may be specified. For example, to select all the games on Jan. 2, 2014, the user may select the date window with starting range Jan. 2, 2014 and ending range Jan. 2, 2014. As another example, to select all games dealt by the dealer Bart Johnson, the user may type in (or select) Bart's name (or Bart's dealer ID).

The alert selection area 1508 provides a graphical interface for the user to specify the alerts that the system is to use in searching the stored game results. The user may specify each alert by using a check box. The alerts selectable include the alerts described above in the Alarms section. For example, to select all games that had an abnormal termination alert, the user may select the check box next to “abnormal termination”.

After specifying the criteria and the alerts to be searched, the user may press a button to instruct the system to perform the search. This button may be located in the criteria selection area 1506 or the alert selection area 1508.

The OR results area 1510 displays the results according to performing a logical OR on the specified criteria and alerts. For example, using the example criteria and alerts selected above, the OR results area 1510 displays all games that occurred on Jan. 2, 2014; all games that were dealt by Bart Johnson; and all games that had an abnormal termination.

The AND results area 1512 displays the results according to performing a logical AND on the specified criteria and alerts. For example, using the example criteria and alerts selected above, the AND results area 1512 displays only the games that occurred on Jan. 2, 2014 that were dealt by Bart Johnson and that had an abnormal termination.

The user can then select an individual game to review from the games listed in the OR results area 1510 or the AND results area 1512, for example by double-clicking on a result.

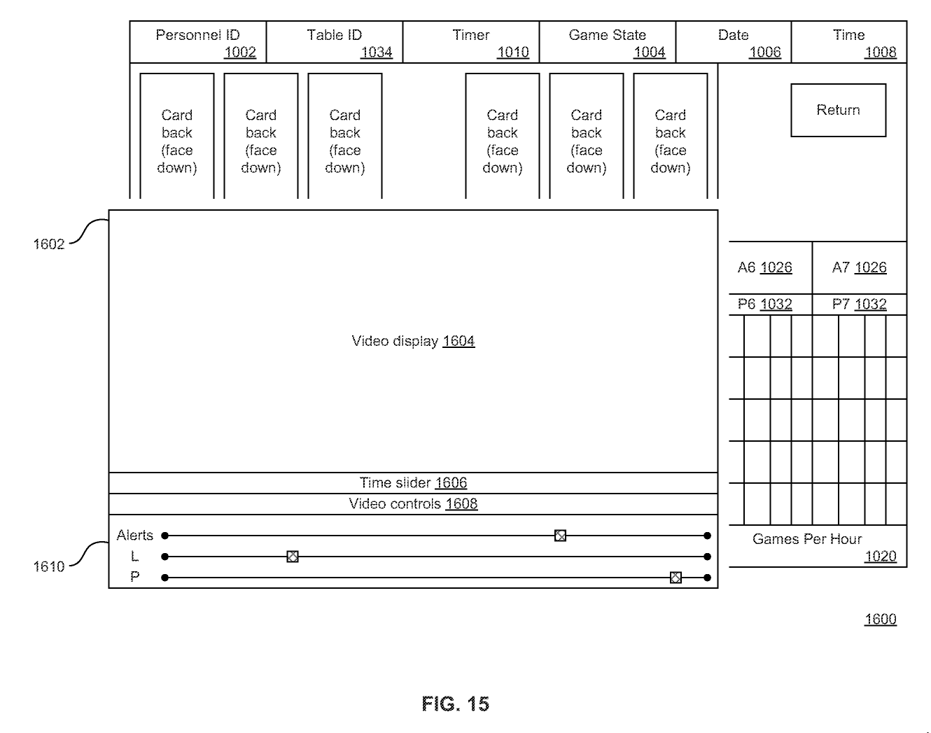

FIG. 15 is an example screen display 1600 showing the game review mode in operation. For example, once a game has been selected for review (see the description above regarding FIG. 14), the user can review the game using the screen display 1600 as the user interface. The screen display 1600 is similar to that of FIG. 10, except that the video area 1022 (see FIG. 10) is detached and enlarged as the video area 1602. The video area 1602 is a moveable and resize-able window. The user can return the video area 1602 to its docked position (e.g., as the video area 1022 in FIG. 10) by using a “return” button. The video area 1602 includes a video display area 1604, a time slider area 1606, a video controls area 1608, and an event markers area 1610.

The video display area 1604 displays the video data 120 (see FIG. 1) in a manner similar to that described above regarding the video area 1022 (see FIG. 10). The video data 120 is displayed in synchrony with the chip data 122 (see FIG. 1) displayed in the bets grid area 1024 (see FIG. 10) and the game result data 124 (see FIG. 1) displayed in the card display area 1012 (see FIG. 10), providing enhanced monitoring abilities to the casino personnel.

The time slider area 1606 displays a user interface for a time slider. The user can use the user interface tools of the system (e.g., a mouse, a touchscreen, etc.) to move the slider to various timestamps. For example, moving the slider all the way to the left goes to the timestamp at the start of the game; moving the slider to the middle goes to a timestamp in the middle of the game.

The video controls area 1608 displays a user interface for controls for controlling the display of the video data 120 (see FIG. 1) in the video display area 1604. Example controls include play, pause, stop, go to beginning, go to end, mute, volume control slider, speed up (time lapse), slow down (slow motion), etc.

The event markers area 1610 displays progress bars that correspond to various events and alerts. Each progress bar correspond to the time slider in the time slider area 1606, to enable the user to select the timestamp to be viewed that corresponds to the event or alert of interest. The example events include the various game states (e.g., pre-game, new game, bet mode, bets locked mode (L), payout mode (P), etc.). For example, the event markers area 1610 shows the bets locked mode L occurred about a third of the way through the recorded game, and the payout mode P occurred at the end of the recorded game. The example alerts include the alerts discussed above in the Alarms section (e.g., late bet, over pay, etc.). For example, if the event markers area 1610 shows that the over pay alert occurred ⅔ of the way through the game, the user can use the time slider in the time slider area 1606 to go to that timestamp in order to review all the game data (video data, chip data, game result data, etc.)

The screen display 1600 illustrates the utility of the combination of events and timestamps. With this information, those responsible for casino security can be quickly alerted to an alarm condition and then review the game with the synchronized video to identify the root cause and take action.

Although the game states and alerts discussed above have particular relevance to Baccarat, similar game states and alerts may correspond to other casino games, and the screen display 1600 is equally adept in displaying the information in a manner that enhances the capabilities of the casino personnel.

Real-Time Feedback

In addition to being able to provide summary reports of game play and time-stamped guides to aid the review of archived games, the system can also provide real-time feedback to help dealers correct issues “in the moment”. In one embodiment, this real-time feedback includes one or more of the following: an indicator of whether the dealer has checked in or not, an indicator of whether the commission/collection is correct or not, an indicator of whether an extra card was erroneously drawn, an indicator to confirm that a “burn” or a “freehand” is in process, and an indicator to show “end of shoe”. A “burn” or “freehand” refers to a practice game or a game in which no bets are made and no house commission is collected. The “burn” or “freehand” may be performed in response to a player request, for example by the dealer pressing a button to communicate the request to the system.

These indicators may be displayed using lights (e.g., a LED), by displaying text or images on a small screen, etc. located at the gaming table. The indicators related to the cards may be displayed on the card shoe (e.g., a red LED turns on to indicate the end of the shoe). The system may send these indicators back to the gaming table using the same connections or network that the gaming table uses to send the data (e.g., video data, game result data, chip data) to the system.

Tracking House Commissions

Often the system may be implemented to include an RFID-enabled drop box. For example, the chip monitor may include an antenna that reads gaming tokens as they pass through the throat of the drop box. This drop box detects the “house ante” (or commission) for each game played at a gaming table and communicates this information to the system. The system uses this information to help manage table games by ensuring the proper ante is collected in proportion to the total value in play, by ensuring that the amount collected at the table is the same as what ends up at the cashier, by monitoring the “hands per hour” by counting the commission drops that occur (one per game), and by defining the game state for automated tracking methods (e.g. RFID). Regarding the “hands per hour”, this information is useful for estimating the income generated by the game and for tracking dealer efficiency. Regarding defining the game state, the new game state may be indicated by the commission being placed in a collection area near the drop box, and the end of game state may be indicated by the commission being dropped into the drop box from the collection area. The system may then use these indications to transition to these states, or to compare these indications with the other measurements to confirm that a state change has occurred.

Casinos and card rooms need an income stream to remain in business. This income stream is typically provided by the “house edge”—a statistical calculation with multiple inputs (e.g., game odds, volume of bets being placed, speed of game play, etc.).

In several jurisdictions including California, laws preclude the house from having a stake in table games. In these cases, the income stream is generated by a “house ante”—essentially a fee charged for each game played. The variables that determine this ante are set by law and may include the type of game, the amount of money in play, and other variables referred to as “the grid”.

Typically, dealers place the “house ante” into a locked drop box mounted into the table. The value of the ante is determined by a combination of rules and how much money is “in play”. At the end of each game, the dealer drops the ante into the drop box. Periodically, a casino employee will remove and replace the locked box and take the tokens to the cashier for subsequent accounting.

As discussed above, the current state-of-the-art for collecting the “house ante” uses a simple metal guillotine to hold the designated chips during a game and subsequently drop them into the lock box. This device has the following short-comings: it cannot monitor the game-by-game take; it cannot insure that the take for any one game matches the expected amount based on the amounts bet; it cannot track the total take for a user-defined time window; it cannot track the “hands per hour”; it cannot evaluate checks and balances between the take at the table and the subsequent tally at the cashier; and it cannot generate any inputs into automated table tracking methods.

The system uses an RFID-enabled drop box to track the commission on a game-by-game basis. When combined with an RFID-enabled gaming table that can track bets (e.g., using the chip monitor) and a-priori knowledge of the rules that govern the commission, the system can compute and verify the proper “ante”. A timestamp can then be used for one or more of the following:
to define a point in time after which further betting is not allowed (e.g., the transition from the new game state to the bets locked state). This can identify “past posting” (late placing of bets), and
to turn on the video stream to capture game play synchronized to RFID tracking of bets and payouts.

Similarly, a timestamp can be generated when the tokens in the drop slot are last read. This captures the action of pulling the slide mechanism. This timestamp can be used for one or more of the following:
to define a point in time that effectively ends the game,
to update remote monitors (e.g., Baccarat results),
to turn off the recording of the video stream, and
to stop the capture of RFID data.

Reports

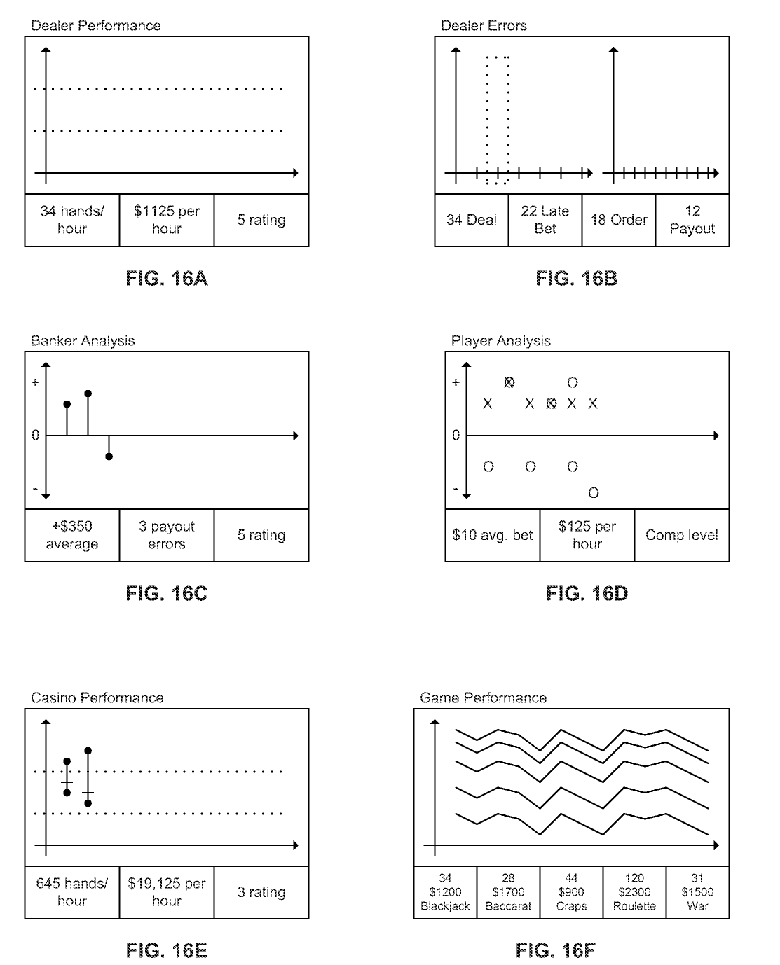

In addition to collecting data on a game-by-game basis, the system can aggregate the data into reports. FIGS. 16A-16F are graphs that show schematically how the system can aggregate the information collected into simple, insightful, useful summaries.

FIG. 16A is a graph showing dealer performance, with sessions (or dealer shifts) on the x-axis and hands per hour (or collection amount per hour) on the y-axis. The y-axis may also include one or more norms (two norms shown as dotted lines) for comparison with the dealer's performance. The dealer's performance may be graphed over multiple sessions, with the following performance metrics shown at the bottom:
average hands per hour,
average table action per hour: the net winnings minus losses for the house (EZ Baccarat outside California), or rate for collecting commissions (in California), and
a rating.

The norms can be a single norm (e.g., an average that dealers are expected to hit), two norms (e.g., an acceptable high rate and an acceptable low rate that dealers are expected to hit between), etc. The average table action per hour is the amount wagered per game, averaged over each hour. The rating is a simple value (e.g., 5-star rating, 1-5 rating, 1-10 rating) that is computed according to whether the dealer has met certain criteria (e.g., 5 stars when the table action per hour is between $1000 and $1200). For example, dealers able to deal at a rate that is 2 standard deviations below the average may be labeled “novices”, while dealers able to deal at a rate that is 2 standard deviations above the average may be labeled “experts”.

FIG. 16B is a graph showing dealer errors, with the left side showing sessions on the x-axis and number of errors on the y-axis. On the right side, for a selected session, the errors (y-axis) are broken out on a per-game basis (x-axis). For example, when session 2 is selected on the left side, the right side shows the errors for the 9 games in that session. The user may select the session to break out by using the user interface tools of the system (e.g., mouse, touch screen, etc.).

In general, FIG. 16B shows dealer errors including: error type(s) and number incurred on a game-by-game basis (right side), error type(s) and number incurred during each session (left side), and aggregate numbers for each error type (bottom). As a specific example, four error types are shown: deal errors, late bet errors, order errors, and payout errors. The deal errors correspond to the extra card drawn alerts. The late bet errors correspond to the late bet alerts. The order errors correspond to the out-of-order collection alerts and the out-of-order payout alerts. The payout errors correspond to the over pay alerts and the under pay alerts. The bottom area may also show an average line for the errors. For example, there are 34 deal errors, which are above average; the 22 late bet errors are above average; the 18 order errors are below average; and the 12 payout errors are below average.

FIG. 16C is a graph showing banker performance, with games on the x-axis and win (or loss) amount on the y-axis. For casinos where the house is the banker (e.g., Las Vegas), this shows the house's performance; for casinos where the house is not the banker (e.g., California), this shows the performance of the banker. The user may select the number of games to be displayed, for example by selecting a time frame, which the system uses to select the game data according to their timestamps. In the example shown, the first two games resulted in increases in the banker's balance increased, and the third game resulted in a decrease to the banker's balance. The bottom shows various summary information, including the average win (or loss) amount for the selected time frame (e.g., +$350), the number of payout errors (e.g., 3), and a rating (e.g., 5). For example, a rating of 1 means the banker is performing at less than 2 standard deviations below average while a rating of 4 means the banker is performing at greater than 1 standard deviation above average.

FIG. 16D is a graph showing player performance, with games on the x-axis and winning (or losing) amounts on the y-axis. More specifically, an “X” on the y-axis shows the bet, and the “O” shows whether the bet won (positive) or lost (negative). The user may select the number of games to be displayed, for example by selecting a time frame, which the system uses to select the game data according to their timestamps. In the example shown, the first bet lost, and the second bet won. The bottom shows various summary information, including the player's average bet (e.g., $10), the total bets by the player on a per-hour average (e.g., $125), and the player's complementary (comp) level (e.g., comped drinks and dinner, no comped room).

FIG. 16E is a graph showing casino performance, with a time period (e.g., days, shifts, etc.) on the x-axis and commissions collected (e.g., California) or net (e.g., Las Vegas) on the y-axis. The y-axis may also include historical norms, such as a high norm and a low norm, that the commission amount or net is expected to fall within. The commission amount or net for each period may be expressed as a bar, showing the high, low and average values. The user may select the number of periods to be displayed, for example by selecting a time frame, which the system uses to select the game data according to their timestamps. The system may compute the casino performance by summarizing the information received from all the tables in the casino. The bottom shows various summary information, including the average hands per hour at the casino (e.g., 645), the average commission amount collected per hour (e.g., $19,125), and a rating (e.g., 3). For example, a rating of 1 means the casino is performing at less than 2 standard deviations below its peers while a rating of 4 means the casino is performing at greater than 1 standard deviation above its peers.

FIG. 16F is a graph showing game performance at the casino, with a time period (e.g., days, shifts, etc.) on the x-axis and commissions collected (e.g., California) or net (e.g., Las Vegas) on the y-axis. Each game (e.g., blackjack, baccarat, craps, roulette, war) may be displayed as a different line on the graph. The user may select the number of periods to be displayed, for example by selecting a time frame, which the system uses to select the game data according to their timestamps. The bottom shows various summary information for each game, including the number of hands per hour and the average commission amount collected per hour (e.g., blackjack shows 34 hands per hour and $1200 average commission).

The system may generate and display reports with other formats and other content, as desired by people familiar with the casino management arts. In general, the user selects a time period and one or more values using the system's user interface. The system selects the games to summarize according to the timestamps of the games within the selected period. The values may be any of the data stored in the system's storage, such as the values displayed in FIGS. 16A-16F. The system displays the selected values on the y-axis over the period on the x-axis.

Additional Features and Details

Additional details for some features discussed above are provided in the following sections.

Gaming Token Identifiers

As discussed above, the gaming tokens have an RFID chip that is read by the chip monitor (e.g., the chip reader device 242 in FIG. 2). The chip monitor reads the identifier stored by the RFID chip and communicates the identifier to the casino monitoring system. The casino monitoring system accesses the casino chip database (e.g., the chip database 112 in FIG. 1) using the identifier, in order to verify that the chip is authorized, to obtain (or verify) the token value, etc.

The information represented by, and the size of, the identifier may vary according to the specific implementation of the chip monitor system and the casino monitoring system. For example, the identifier may be 32 bits, 64 bits, etc. The identifier may include a manufacturer identifier, a casino identifier, a value identifier, and a gaming token identifier. At least some of the information in the identifier may be redundant with the information stored in the chip database. For example, the identifier may include information that the chip value is $100, which information is also stored in the chip database; the casino monitoring system may use this redundancy to perform an additional verification.

Commission Schedules

As discussed above, the system stores various commission schedules (e.g., in the storage 104 of FIG. 1). Given the information received from the gaming table, the system can use that information to determine the appropriate commission amount.

An example of the information used in the commission schedule are the minimum and maximum bets allowed (e.g., $25-$1000), the total amount of table action (e.g., $5-$500), etc. The minimum and maximum bets allowed are generally set on a per-table basis, and the system knows which table is sending its data (e.g., each table tags the data sent to the system with a table identifier). The total amount of table action for a table is determined according to the chip data 122 (see FIG. 1) received at the appropriate time, which is known according to the game rules (e.g., stored in the game rule database 114 of FIG. 1). For example, the total table action may be measured during the “bets locked” state (see FIG. 12 and related description).

Other information that the commission schedule may include is the location of the casino (e.g., California, Nevada, etc.), the specific casino (e.g., Casino A may be approved to charge one rate and Casino B may be approved to charge another rate, etc.), the game type (e.g., Baccarat, blackjack, roulette, craps, poker, etc.), etc.

Dealer Identification

As discussed above, the gaming table sends dealer identification information to the system. One way for the table to identify the dealer is that when a dealer arrives at the table, the dealer checks in (e.g., the table reads the dealer's badge via RFID, barcode, etc.), and when the dealer leaves, the dealer checks out. The gaming table may display confirmation that the dealer has been checked in (e.g., lighting a green LED, displaying the dealer's name on a screen, etc.) or checked out (e.g., lighting a red LED, displaying a “no dealer” message on a screen, etc.). The gaming table sends the dealer identification to the system; the system associates the dealer identification with the other information sent by the gaming table (e.g., the video data, the chip data and the game result data), and uses the dealer identification for monitoring and reporting.

Player Identification

As discussed above, the gaming table sends player (customer) identification information to the system. One way for the table to identify the player is using reward cards. When a player arrives at a table, the table reads the reward card (e.g., via RFID, barcode, etc.), to check the player in to the table (or to a particular seated player position at the table). When the player leaves, the gaming table performs a “check out” to inform the system that the player is no longer present at the table. The check out may be manual (e.g., the dealer pushes a button corresponding to the player leaving), reward card based (e.g., the table no longer detects the presence of the reward card), facial recognition based (e.g., the system compares the current facial recognition data for a seated player position with facial recognition data obtained when the player checked in to the table), etc. The gaming table sends the player identification to the system; the system associates the player identification with the other information sent by the gaming table (e.g., the video data, the chip data and the game result data), and uses the player identification for monitoring and reporting.

Complimentary (Comp) Tracking

As discussed above (see FIG. 16D and related discussion), the system may track a player's complementary (comp) level. The system knows the player associated with each bet (e.g., the table reads each player's reward card and sends the chip data 112 of FIG. 1 such that each bet is tagged with each respective player's identification) and computes the comp level according to a defined comp schedule. For example, using the data shown in FIG. 16D, the system can determine the value of individual winning bets of different types (each with different house odds); if the player makes bets that are good for the house, the player's comp level may be increased. The system can determine the value of individual losing bets of different types; if the player makes a large amount of losing bets, the player's comp level may be increased. In addition, the player's comp level may be increased according to other criteria, such as the duration of play (how long the player was at a table), etc.

Dealer Tray Monitoring

For certain casino games, the dealer is in charge of a dealer tray that contains gaming tokens. The dealer uses the gaming tokens in the tray when performing various actions, such as converting cash to gaming tokens, “coloring up” (e.g., converting twenty $5 chips to one $100 chip), paying out winning bets, collecting losing bets, etc. The chip monitor at the table monitors the dealer tray when it is collecting the chip data 122 (see FIG. 1). Thus, the system is able to monitor the value of the chips in the dealer tray and to correlate this with wins and losses, the cash in or out, and tips.

Game Result Monitoring

As described above for Baccarat, the game result monitor is a card monitor (e.g., the card reader 244 of FIG. 2 or the OCR component 344 of FIG. 3), the game result data is card data (e.g., cards are detected), and the game result identifier is a card identifier (e.g., the rank of the card, the rank and suit, etc.). Other types of game result monitors may be used in other types of casino games (e.g., that have game results based on things other than cards, such as dice or roulette results).

For dice games (e.g., craps), the game result monitor is a dice monitor. The dice monitor may be implemented with an OCR system (e.g., similar to the OCR component 344 of FIG. 3). The game result data is dice data (e.g., a die is detected), and the game result identifier is a dice identifier (e.g., the number on a die, the sum of multiple dice, etc.).

For roulette, the game result monitor is a roulette monitor. The roulette monitor may be implemented with an OCR system (e.g., similar to the OCR component 344 of FIG. 3). The game result data is roulette data (e.g., a roulette result is detected), and the game result identifier is a roulette identifier (e.g., the number on the roulette wheel that the ball ends on). Alternatively, the roulette ball may have an RFID chip, and the roulette wheel may be instrumented with RFID antennas to detect the roulette ball, in a manner similar to that described above regarding the chip reader 242 (see FIG. 2).

In sum, the system is generally operable with any table game that uses cards, dice, or a roulette wheel; RFID gaming tokens placed on betting spots; and an overhead camera.

Synergy of Combining Identifications

The combination of these identifications enables an unexpected synergy. Using the card information to track the state of the game allows for the identification of chip actions that are invalid (as well as tracking the correct commission) that can generate alerts in real time. Adding video data with timestamps allows for subsequent review. Such synergy greatly reduces the time involved in identifying invalid actions.

Synergy arises from the combination of chip identification and card identification beyond the linear combination of these two features. Specifically, one set of alerts are applicable at one point in the game, and another set of alerts are applicable at another point. The system uses the card data to determine which alerts are applicable in which state.

Note that additional synergy arises from the combination of all three of video, chip identification and card identification. For example, combining video and chip identification, without card identification, would not allow the system to know who won and who lost and therefore could not track proper/improper payouts. As a second example, combining video and card identification, without chip identification, would not allow the system to know what bets have been placed, whether winning bets had been correctly paid out, the amount of table action, and any corresponding house commission. As a third example, combining chip identification and card identification, without video, would not enable casino personnel to determine who (player 1, player 2, dealer, etc.) made a particular action such as a late bet. The addition of a loyalty card into the database further enriches the value of the information collected, allowing targeted marketing based on individual player profiles. The addition of an instrumented drop slot allows game-by-game cash management of the drop box. And the addition of an instrumented dealer tray allows game-by-game cash management at each table.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method of monitoring events in a casino environment, comprising the steps of:
receiving, from a video camera, video data of a table game in the casino environment;
receiving, from a radio-frequency identification chip monitor, casino chip data of the table game, wherein the casino chip data includes at least one casino chip location and at least one casino chip identifier;
receiving, from a game result monitor, game result data of the table game, wherein the game result data includes at least one game result identifier; and
displaying together the video data, the casino chip data and the game result data to enhance monitoring of the events at the table game.

2. The method of claim 1, wherein the casino chip data is received contemporaneously with the video data.

3. The method of claim 1, wherein the game result data is received contemporaneously with the video data.

4. The method of claim 1, further comprising:
storing the video data, the casino chip data and the game result data having been received.

5. The method of claim 1, wherein the video data has a plurality of video data timestamps, wherein the casino chip data has a plurality of casino chip data timestamps, wherein the game result data has a plurality of game result data timestamps, wherein displaying together the video data, the casino chip data and the game result data comprises:
displaying together the video data, the casino chip data and the game result data using the plurality of video data timestamps, the plurality of casino chip data timestamps, and the plurality of game result data timestamps.

6. The method of claim 1, wherein the video data has a plurality of video data timestamps, wherein the casino chip data has a plurality of casino chip data timestamps, wherein the game result data has a plurality of game result data timestamps, further comprising:
receiving a user input that selects a timestamp; and
displaying together the video data, the casino chip data and the game result data at the timestamp selected by the user input.

7. The method of claim 1, further comprising:
accessing a chip database using the at least one casino chip identifier;
receiving, from the chip database, at least one casino chip value that corresponds to the at least one casino chip identifier; and
displaying the at least one casino chip value when displaying the casino chip data.

8. The method of claim 1, wherein the at least one casino chip location is a dealer tray, wherein the at least one casino chip identifier is at least one casino chip being located in the dealer tray, wherein displaying the casino chip data enhances monitoring of the at least one casino chip being located in the dealer tray.

9. The method of claim 1, wherein the radio-frequency identification chip monitor is a radio-frequency identification drop box, wherein the at least one casino chip location is a read area of the radio-frequency identification drop box, wherein the at least one casino chip identifier is at least one casino chip being located in the read area, wherein displaying the casino chip data enhances monitoring of the at least one casino chip being located in the read area.

10. The method of claim 1, further comprising:
accessing a commission schedule, wherein the at least one casino chip location is a read area of the radio-frequency identification drop box, wherein the at least one casino chip identifier is at least one casino chip being located in the read area;
computing a commission amount by applying the commission schedule to the at least one casino chip being located in the read area; and
displaying the commission amount when displaying the video data, the casino chip data and the game result data.

11. The method of claim 1, further comprising:
accessing rules of the table game;
monitoring the casino chip data to identify when a violation of the rules of the table game has occurred; and
generating an alert when the casino chip data indicates that the violation has occurred.

12. The method of claim 1, further comprising:
accessing rules of the table game, wherein the rules are associated with a set of states; and
changing from a first state of the set of states to a second state of the set of states according to the game result data.

13. The method of claim 1, further comprising:
receiving customer identification data corresponding to a customer participating in the table game;
correlating the customer identification data with the casino chip data; and
displaying the customer identification data having been correlated to enhance evaluating the customer.

14. The method of claim 1, further comprising:
receiving dealer identification data corresponding to a dealer operating the table game;
correlating the dealer identification data with the casino chip data and the game result data; and
displaying the dealer identification data having been correlated to enhance evaluating the dealer.

15. The method of claim 1, wherein the game result monitor is one of a card monitor, a roulette monitor and a dice monitor.

16. An apparatus for monitoring events in a casino environment, comprising:
a video camera that generates video data of a table game in the casino environment;
a radio-frequency identification chip monitor that generates casino chip data of the table game, wherein the casino chip data includes at least one casino chip location and at least one casino chip identifier;
a game result monitor that generates game result data of the table game, wherein the game result data includes at least one game result identifier; and
a computer system that receives and displays together the video data, the casino chip data and the game result data to enhance monitoring of the events at the table game.

17. A computer program stored on a non-transitory computer readable medium that controls a computer system to monitor events in a casino environment, comprising:
a video component that receives video data of a table game in the casino environment;
a chip monitor component that receives casino chip data of the table game, wherein the casino chip data includes at least one casino chip location and at least one casino chip identifier;
a game result monitor component that receives game result data of the table game, wherein the game result data includes at least one game result identifier; and
an output component that outputs together the video data, the casino chip data and the game result data to enhance monitoring of the events at the table game.

18. A method of monitoring events in a casino environment, comprising the steps of:
receiving, from a radio-frequency identification chip monitor, casino chip data of the table game, wherein the casino chip data includes at least one casino chip location and at least one casino chip identifier;
receiving, from a game result monitor, game result data of the table game, wherein the game result data includes at least one game result identifier;
accessing rules of the table game according to the at least one game result identifier;
monitoring the casino chip data to identify when a violation of the rules of the table game has occurred; and
generating an alert when the casino chip data indicates that the violation has occurred.
